(19) United States
(12) Patent Application Publication
(10) Pub. No.: US 2024/0141087 A1
(43) Pub. Date: May 2, 2024

(54) POLYCYCLIC-OLEFINIC POLYMERS CONTAINING ACRYLATE FUNCTIONALITY WITH ACRYLATE/MALEIMIDE CROSSLINKERS AS B-STAGEABLE COMPOSITIONS FOR LOW LOSS APPLICATIONS

(71) Applicant: PROMERUS, LLC, Akron, OH (US)

(72) Inventors: PRAMOD KANDANARACHCHI, AKRON, OH (US); PAUL D. BYRNE, AKRON, OH (US); LARRY F. RHODES, AKRON, OH (US)

(73) Assignee: PROMERUS, LLC, AKRON, OH (US)

(21) Appl. No.: 18/243,347

(22) Filed: Sep. 7, 2023

Related U.S. Application Data
(60) Provisional application No. 63/404,342, filed on Sep. 7, 2022.

(51) Int. Cl. C08F 232/08; C08J 5/18; C08K 5/14; C08L 45/00

(52) U.S. Cl. CPC C08F 232/08; C08J 5/18; C08K 5/14; C08L 45/00; C08F 2800/10; C08F 2810/20; C08J 2345/00; C08L 2203/16; C08L 2205/06; C08L 2312/00

(57) ABSTRACT

Embodiments in accordance with the present invention encompass copolymers, terpolymers and tetrapolymers of a variety of polycycloolefinic monomers at least one of which monomer contains an unpolymerized acrylate group. In further aspect of this invention there is provided an embodiment encompassing compositions containing the polymers of this invention, a crosslinker, a free radical initiator, a tackifier and one or more suitable additives. There is also provided a mass polymerizable composition encompassing one or more polycycloolefinic monomers optionally containing a monomer with an acrylate group and/or a crosslinking agent containing multi-functional acrylate. The compositions of this invention can be formed into a variety of three-dimensional insulating articles upon exposure to suitable high temperature, such as for example films. The objects formed from the compositions of this invention exhibit hitherto unattainable low dielectric constant and low-loss properties, and very high thermal properties. The compositions of this invention may additionally contain one or more organic or inorganic filler materials, which provide improved thermo-mechanical properties in addition to very low dielectric properties. The compositions of this invention are useful in various applications, including as insulating materials in millimeter wave radar antennas, among others.

### CROSS REFERENCE TO RELATED APPLICATIONS

This application claims the benefit of U.S. Provisional Application No. 63/404,342, filed Sep. 7, 2022, which is incorporated herein by reference in its entirety.

### BACKGROUND OF THE INVENTION

### Field of the Invention

Embodiments in accordance with the present invention relate generally to polymers formed from two or more polycycloolefinic monomers at least one of which monomers containing an acrylate functionality. More specifically, this invention relates to a polymer containing two or more substituted norbornene derivatives among which at least one monomer contains at least one free acrylate functionality. The embodiments of this invention further relate to compositions containing such polymers in combination with a tackifier, a crosslinker, a free radical initiator and one or more additives. The compositions of this invention can readily be formed into films, which are useful as low loss thermosets and prepregs for copper clad laminates which not only exhibit low dielectric constant and low-loss properties but also very high thermal properties. For example, films formed from the compositions of this invention generally exhibit high glass transition temperature, which range from about 150° C. to 280° C., and also exhibit low dielectric constant (from about 2.2 to 3.0 at a frequency of 10 GHz), low dielectric dissipation factor (from about 0.001 to 0.002 at a frequency of 10 GHz), and coefficient of thermal expansion (CTE) as low as 60 ppm/K. Accordingly, the polymers and composition of this invention find applications as insulating materials in a variety of applications including electromechanical devices having applications in the fabrication of a number of automotive parts, among others.

### DESCRIPTION OF THE ART

It is well known in the art that insulating materials having low dielectric constant (Dk) and low-loss, also referred to as dielectric dissipation factor, (Df) are important in printed circuit boards catering to electrical appliances and automotive parts and other applications. Generally, in most of such devices the insulating materials that are suitable must have dielectric constant lower than 3 and low-loss lower than 0.002 at high frequencies such as for example greater than 10 GHz. Also, there is an increased interest in developing organic dielectric materials as they are easy to fabricate among other advantages.

However, the use of such materials in printed circuit boards as copper-clad laminates need high performance thermosets having high glass transition temperatures (T_{g}), low CTEs, low Dk/Df, high peel strength on copper and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in the art have not attained all of these properties, especially low Dk/Df and high glass transition temperatures, higher than 150° C.

In addition, there are significant technical challenges in developing such insulating materials meeting all of the requirements. One such challenge is that such materials exhibit low coefficient of thermal expansion (CTE), which is preferably less than 50 ppm/K due to concerns of peeling from copper layers. Another challenge is that such materials exhibit very high glass transition temperature (T_{g}), which is preferably greater than 150° C. or even higher than 250° C. due to the process conditions used in the manufacture of printed circuit boards as well as harsh conditions the devices may encounter, such as for example millimeter-wave Radar antennas used in the automobiles and other terminal equipment in 5G devices.

Although films made from the addition polymerization of norbornene derivatives containing long side chains, such as for example, 5-hexylnorbornene (HexNB) and 5-decylnorbornene (DecNB) are known to have low Dk and Df due to their hydrophobic nature these films exhibit high CTE (>200 ppm/K) and low T_{g}. See, for example, JP 2016037577A and JP 2012121956A.

It has also been reported in the literature that certain of the polymers, such as for example, fluorinated poly-ethylene, poly-ethylene, and poly-styrene feature low Dk/Df but all of such polymers are unsuitable as organic insulating materials as they exhibit very low glass transition temperatures, which can be much lower than 150° C. Further, it has also been reported in the literature that generally low CTE and high T_{g} polymers can be generated when certain substituted norbornenes substituted with polar groups such an ester or alcohol groups are incorporated. However, incorporation of such groups will increase both Dk and Df due to their polarizability under an electromagnetic field, particularly at high frequencies. Therefore, such polar group substituted norbornenes are unsuitable in forming insulating materials as contemplated herein.

U.S. Pat. No. 10,897,818 B2 discloses a composition containing modified polyphenylene ether containing vinyl benzyl end groups, a cross linker such as 1,3,5-triallyl-1,3,5-triazinane-2,4,6-trione, also known as triallyl isocyanurate (TAIC) and an epoxy compound. However, the compositions reported therein exhibit high Dk of about 3.7 and Df of about 0.005 albeit reasonably high T_{g} ranging from about 200-230° C.

Therefore, there is still a need to develop new insulating materials that exhibit not only low dielectric properties but also very high thermal properties.

In addition, there is also a need to develop materials, which can form thermoset films rather than thermoplastic films. That is, the thermosets are generally cross-linked structures, which are more stable to higher temperatures and do not exhibit any thermal mobility unlike thermoplastics.

Accordingly, it is an object of this invention to provide a polymer containing two or more monomers of substituted norbornenes, one of which monomer contains at least one acrylate functionality, and a composition derived therefrom which can be formed into an insulating material having hitherto unattainable properties.

Other objects and further scope of the applicability of the present invention will become apparent from the detailed description that follows.

### SUMMARY OF THE INVENTION

Surprisingly, it has now been found that employing a polymer containing two or more polycyclic olefinic monomers of formulae (I) and (II) as described herein which contain at least four or more mole percent of a monomer of formula (II), it is now possible to form a polymer, which can be used in compositions as described herein to form a variety of three-dimensional objects, including films, which provide hitherto unattainable dielectric as well as thermal properties.

In another aspect of this invention there is also provided a film, a composite, a prepreg comprising the composition of this invention.

### BRIEF DESCRIPTION OF THE DRAWINGS

Embodiments in accordance with the present invention are described below with reference to the following accompanying FIGURES and/or images. Where drawings are provided, it will be drawings which are simplified portions of various embodiments of this invention and are provided for illustrative purposes only.

FIG. 1 shows graphical plots of dielectric reliability studies at a storage temperature of 125° C. over a period of 1000 hours of a few of the exemplary films formed from the compositions of this invention, which are compared with comparative compositions available in the art as described herein.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy,” “thioalkyl,” “alkoxyalkyl,” “hydroxyalkyl,” “alkylcarbonyl,” “alkoxycarbonylalkyl,” “alkoxycarbonyl,” “diphenylalkyl,” “phenylalkyl,” “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy,” “cycloalkylalkyl,” “cycloalkylaryl,” “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine, or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy,” is to be construed accordingly. It should further be noted that certain of the alkyl groups as described herein may partially be fluorinated, that is, only portions of the hydrogen atoms in said alkyl group are replaced with fluorine atoms and shall be construed accordingly.

As used herein the expression “acyl” shall have the same meaning as “alkanoyl,” which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight, or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals.

As used herein, the expression “heterocycle” includes all of the known reduced heteroatom containing cyclic radicals. Representative 5-membered heterocycle radicals include tetrahydrofuranyl, tetrahydrothiophenyl, pyrrolidinyl, 2-thiazolinyl, tetrahydrothiazolyl, tetrahydrooxazolyl, and the like. Representative 6-membered heterocycle radicals include piperidinyl, piperazinyl, morpholinyl, thiomorpholinyl, and the like. Various other heterocycle radicals include, without limitation, aziridinyl, azepanyl, diazepanyl, diazabicyclo[2.2.1]hept-2-yl, and triazocanyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₂-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples, and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

As used herein, “B-stage” means a material wherein the reaction between the base polymer and the curing agent/hardener is not complete. That is, such “B-staged” material is in a partially cured stage, and generally free of any solvent used to make the composition containing the base polymer and the curing agent/hardener. Generally, when such “B-staged” material is reheated at elevated temperature, the cross-linking is complete, and the material is fully cured.

As used herein, “prepreg” means a material that is pre-impregnated with a polymeric material which can be either a thermoplastic or a thermoset. Generally, a fibrous material such as glass cloth is pre-impregnated with a polymeric material to form prepregs, which is formed by a “B-stage” process and subsequently cured by reheating at elevated temperature.

By the term “derived” is meant that the polymeric repeating units are polymerized (formed) from, for example, polycyclic norbornene-type monomers in accordance with formulae (I) or (II) wherein the resulting polymers are formed by 2,3 enchainment of norbornene-type monomers as shown below:

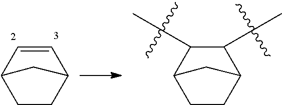

The above polymerization is also known widely as vinyl addition polymerization typically carried out in the presence of organometallic compounds such as organopalladium compounds or organonickel compounds as further described in detail below.

Thus, in accordance with the practice of this invention there is provided a polymer comprising:
a) at least one first repeating unit represented by formula (IA), said first repeating unit is derived from a monomer of formula (I):

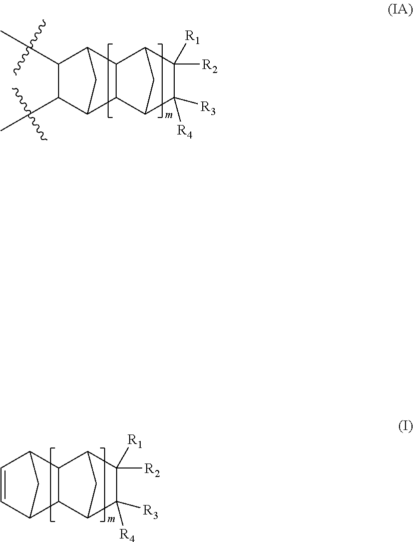

wherein:
[symbol] denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl, (C₆-C₁₂)aryl(C₁-C₆)alkyl, methylidene, ethylidene, vinyl, linear or branched (C₃-C₁₆)alkenyl, (C₃-C₁₀)cycloalkenyl, (C₆-C₁₂)bicycloalkenyl, (C₆-C₁₂)aryl(C₂-C₁₆)alkenyl, epoxy(C₁-C₆)alkyl and epoxy(C₃-C₈)cycloalkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II):

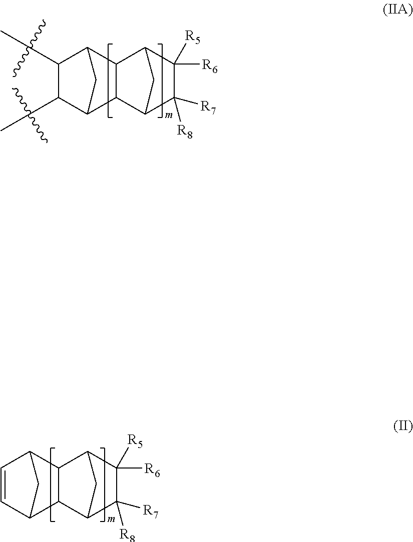

wherein:
[symbol] denotes a place of bonding with another repeat unit;
n is an integer 0, 1 or 2;
at least one of R₅, R₆, R₇ and R₈ is selected from the group consisting of acrylate, methacrylate, (C₁-C₆)alkylacrylate and (C₁-C₆)alkylmethacrylate, and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the second repeat unit is present at an amount not less than four mole percent based on total moles of first and second repeat units.

The polymer as described herein can be prepared by any of the known vinyl addition polymerization in the art. It has now been found that the copolymerization of one or more monomers of formula (I) with one or more monomers of formula (II) it is now possible to form polymers in accordance with this invention where the acrylate functionality present in monomer of formula (II) remains unreactive during vinyl addition polymerization and such functionality remains available in the polymer for other uses. Thus, for example, the polymers of this invention can be used in a variety of applications where further crosslinking with other materials can be carried out. Such methods include formation of prepregs suitable in the fabrication of printed circuit boards, such as copper clad laminates. It has now been found that even incorporation of small amounts of monomer of formula (II) it is now possible to form polymers in accordance with this invention which are quite effective in forming crosslinkable compositions of this invention as described in detail below.

Advantageously, it has now been found that the acrylate functionality present in the monomers of formula (II) is not reactive to the vinyl addition polymerization catalyst, and therefore remains present after formation of the polymer in accordance with this invention. That is, acrylate group present in R₅, R₆, R₇ and R₈ of the monomer of formula (II) remains available in the polymer formed in accordance with this invention. Therefore, the polymers of this invention are useful in a variety of applications where there is a need for further reaction involving the olefinic functionality, such as for example, crosslinking with other materials. It has been further observed that the amount of monomer of formula (II) employed can be as little as four (4) mole percent of the total amount of combined monomers of formulae (I) and (II) in order to observe the crosslinking ability of the polymers of this invention.

Accordingly, in some embodiments the amount of repeat units of monomer of formula (IIA) present in the polymer is at least four mole percent based on the total moles of first and second repeat units of formulae (IA) and (IIA). In some other embodiments the amount of repeat units of monomer of formula (IIA) present in the polymer is from about five mole percent to about forty mole percent, from about ten mole percent to about thirty mole percent, from about fifteen mole percent to about twenty-five mole percent, and so on, based on the total moles of first and second repeat units of formulae (IA) and (IIA). In yet some other embodiments the amount of repeat units of monomer of formula (IIA) present in the polymer is from about six mole percent to thirty mole percent based on the total moles of first and second repeat units of formulae (IA) and (IIA).

As noted, more than one monomer of formula (I) with at least one monomer of formula (II) can be used to form the polymer of this invention. Advantageously, it has now been found that at least two distinctive monomers of formula (I) are employed with at least one monomer of formula (II). Again, any desirable amounts of distinctive monomers of formula (I) can be used in combination with a monomer of formula (II) as described herein. In some embodiments such molar ratios of distinctive monomers of formula (I) can be 10:90, 20:80, 30:70, 40:60, 50:50, and so on. In some embodiments three or more distinctive monomers of formula (I) are employed with at least one monomer of formula (II). Again, any desirable amounts of three distinctive monomers of formula (I) can be used in combination with a monomer of formula (II) as described herein. In some embodiments such molar ratios of distinctive monomers of formula (I) can be 10:10:80, 10:20:70, 20:30:50, 10:40:50, 40:40:20, and so on.

In some embodiments, the polymer according to this invention is having a repeat units of formula (IA) wherein m is 0 or 1. In some other embodiments, the polymer according to this invention is having a repeat units of formula (IA) wherein m is zero. That is, the repeat units of formula (IA) are derived from a monomer of formula (I), which is a derivative of norbornene. Again, one or more distinct monomers of formula (I) can be used to form the polymer of this invention. In some other embodiments the monomer of formula (I) employed is having m equals 1. That is, the monomer employed in this embodiment contains a dimeric norbornene monomer unit, which is also known as tetracyclodecene (TD). However, it should be noted that a combination of monomers of formula (I) having m=0 and m=1 can also be used to form the polymer of this invention. That is, a mixture of norbornene derivatives of formula (I) as described herein can be employed with a suitable tetracyclodecene derivative of formula (I) as described herein can be used to form the polymer of this invention. Again, any suitable amounts of these distinct monomers of formula (I) which will bring about the intended benefit can be employed to form the polymers of this invention. Accordingly, in some embodiments, the polymer according to this invention, encompasses the first repeat unit derived from two distinct monomers of formula (I).

Similarly, in some other embodiments, the polymer according to this invention is having a repeat units of formula (IIA) wherein n is 0 or 1. In some other embodiments, the polymer according to this invention is having a repeat units of formula (IIA) wherein n is zero. That is, the repeat units of formula (IIA) are derived from a monomer of formula (II), which is a derivative of norbornene. Again, one or more distinct monomers of formula (II) can be used to form the polymer of this invention. In some other embodiments the monomer of formula (II) employed is having n equals 1. That is, the monomer employed in this embodiment contains a dimeric norbornene monomer unit, which is also known as tetracyclodecene (TD). However, it should be noted that a combination of monomers of formula (II) having n=0 and n=1 can also be used to form the polymer of this invention. That is, a mixture of norbornene derivatives of formula (II) as described herein can be employed with a suitable tetracyclodecene derivative of formula (II) can be used to form the polymer of this invention. Again, any suitable amounts of these distinct monomers which will bring about the intended benefit can be employed to form the polymers of this invention. Accordingly, in some embodiments two distinctive monomers of formula (II) are employed to form the polymer of this invention.

In some embodiments, R₁, R₂, R₃ and R₄ are the same or different and each independently selected from the group consisting of hydrogen, methyl, ethyl, n-propyl, n-butyl, n-hexyl, cyclopentyl, cyclohexyl, norbornyl, ethylidene, vinyl, propenyl, butenyl, pentenyl, hexenyl, heptenyl, octenyl, cyclopentenyl, cyclohexenyl and epoxycyclohexyl.

In some other embodiments, one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring.

In yet some other embodiments, at least one of R₅, R₆, R₇ and R₈ is selected from the group consisting of acryloyl, methylacryloyl, ethylacryloyl, methacryloyl, methylmethacryloyl and ethylmethacryloyl, and the remaining R₅, R₆, R₇ and R₈ are the same or different and each independently selected from the group consisting of hydrogen, methyl, ethyl, n-propyl, n-butyl, n-hexyl, cyclopentyl, cyclohexyl and norbornyl.

In some embodiments, one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

Again, any of the monomers of formula (I) within the scope of this invention can be employed to form the polymers of this invention. Non-limiting examples of such monomers of formula (I) may be selected from the group consisting of:

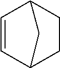

bicyclo[2.2.1]hept-2-ene (norbornene or NB);

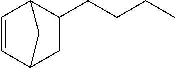

5-butylbicyclo[2.2.1]hept-2-ene (BuNB);

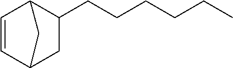

5-hexylbicyclo[2.2.1]hept-2-ene (HexNB);

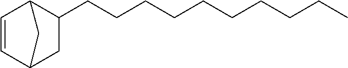 [SMILES: CCCCCCCCCCC1CC2C=CC1C2]

5-decylbicyclo[2.2.1]hept-2-ene (DecNB);

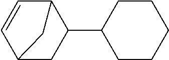 [SMILES: C1=CC2CC1CC2C1CCCCC1]

5-cyclohexylbicyclo[2.2.1]hept-2-ene (CyHexaneNB);

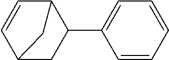 [SMILES: C1=CC2CC1CC2c1ccccc1]

5-phenylbicyclo[2.2.1]hept-2-ene (PhNB);

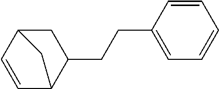 [SMILES: C1=CC2CC1CC2CCc1ccccc1]

5-phenethylbicyclo[2.2.1]hept-2-ene (PENB);

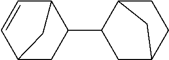 [SMILES: C1=CC2CC1CC2C1CC2CCC1C2]

2,2′-bi(bicyclo[2.2.1]heptan-5-ene) (NBANB);

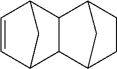 [SMILES: C1=CC2CC1C1C3CCC(C3)C21]

1,2,3,4,4a,5,8,8a-octahydro-1,4:5,8-dimethanonaphthalene (TD);

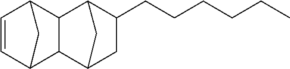 [SMILES: CCCCCCC1CC2CC1C1C3C=CC(C3)C21]

2-hexyl-1,2,3,4,4a,5,8,8a-octahydro-1,4:5,8-dimethanonaphthalene (HexTD);

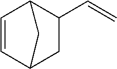

5-vinylbicyclo[2.2.1]hept-2-ene (VNB);

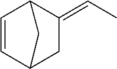

5-ethylidenebicyclo[2.2.1]hept-2-ene (ENB);

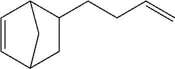

5-(but-3-en-1-yl)bicyclo[2.2.1]hept-2-ene (ButenylNB);

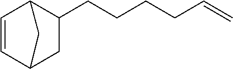

5-(hex-5-en-1-yl)bicyclo[2.2.1]hept-2-ene (HexenylNB);

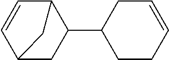 [SMILES: C1=CCC(C2CC3C=CC2C3)CC1]

5-(cyclohex-3-en-1-yl)bicyclo[2.2.1]hept-2-ene (CyHexeneNB);

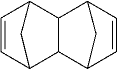 [SMILES: C1=CC2CC1C1C3C=CC(C3)C21]

1,4,4a,5,8,8a-hexahydro-1,4:5,8-dimethanonaphthalene (TDD);

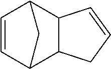

3a,4,7,7a-tetrahydro-1H-4,7-methanoindene (DCPD);

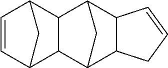 [SMILES: C1=CC2C(C1)C1CC2C2C3C=CC(C3)C12]

3a,4,4a,5,8,8a,9,9a-octahydro-1H-4,9:5,8-dimethanocyclopenta[b]naphthalene (CPD3); and

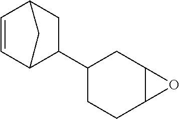 [SMILES: C1=CC2CC1CC2C1CCC2OC2C1]

3-(bicyclo[2.2.1]hept-5-en-2-yl)-7-oxabicyclo[4.1.0]heptane (CHEpNB).

Similarly, any of the monomers of formula (II) within the scope of this invention can be employed to form the polymers of this invention. Non-limiting examples of such monomers of formula (II) may be selected from the group consisting of:

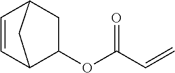

bicyclo[2.2.1]hept-5-en-2-yl acrylate (NB-acrylate);

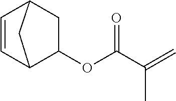

bicyclo[2.2.1]hept-5-en-2-yl methacrylate (NB-methacrylate);

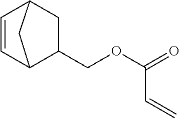

bicyclo[2.2.1]hept-5-en-2-ylmethyl acrylate (NBCH2-acrylate); and

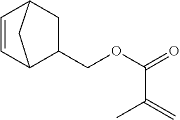

bicyclo[2.2.1]hept-5-en-2-ylmethyl methacrylate (NBCH2-methacrylate).

Exemplary non-limiting examples of polymer according to this invention may be enumerated as follows:
a tetrapolymer of norbornene (NB), 5-hexylbicyclo[2.2.1]hept-2-ene (HexNB), 5-cyclohexylbicyclo[2.2.1]hept-2-ene (CyHexaneNB) and bicyclo[2.2.1]hept-5-en-2-yl methacrylate (NB-methacrylate); and
a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate).

Surprisingly, it has now been observed that employing even small amounts of about four mole percent of a monomer of formula (II) based on the total moles of monomers of formulae (I) and (II) it is now possible to form a polymer according to this invention which brings about effective crosslinking ability with other materials in forming a composite material having utility in a variety of applications as described hereinbelow. In some embodiments, the polymer according to this invention encompasses the second repeat unit of formula (II), which is present at an amount in the range from about five mole percent to about thirty mole percent based on the total moles of first repeat unit(s) of formula (I) and second repeat unit(s) of formula (II). In some other embodiments, the polymer according to this invention encompasses the second repeat unit of formula (II), which is present at an amount in the range from about ten mole percent to about twenty-five mole percent based on the total moles of first repeat unit(s) of formula (I) and second repeat unit(s) of formula (II). In yet some other embodiments, the polymer according to this invention encompasses the second repeat unit of formula (II), which is present at an amount in the range from about fifteen mole percent to about twenty mole percent based on the total moles of first repeat unit(s) of formula (I) and second repeat unit(s) of formula (II). However, it should be noted that in some embodiments the amount of repeat unit of formula (II) may be less than four mole percent or also can be higher than thirty mole percent depending upon the intended application. Accordingly, all such possible combinations of amounts that can be employed are well within the scope of this invention.

As noted, the monomers of formulae (I) and (II) undergo vinyl addition polymerization using any of the suitable catalysts known in the art. For example, various palladium compounds, platinum compounds as well as various nickel compounds have been used to form polymers of the types described herein. In some embodiments of this invention the polymer of this invention is formed by employing a palladium compound. Various palladium compounds known in the art can be employed. Non-limiting examples of such palladium compounds, including a few platinum compounds may be enumerated as follows:
palladium (II) bis(triphenylphosphine) dichloride;
palladium (II) bis(triphenylphosphine) dibromide;
palladium (II) bis(triphenylphosphine) diacetate;
palladium (II) bis(triphenylphosphine) bis(trifluoroacetate);
palladium (II) bis(tricyclohexylphosphine) dichloride;
palladium (II) bis(tricyclohexylphosphine) dibromide;
palladium (II) bis(tricyclohexylphosphine) diacetate (Pd785);
palladium (II) bis(tricyclohexylphosphine) bis(trifluoroacetate);
palladium (II) bis(tri-p-tolylphosphine) dichloride;
palladium (II) bis(tri-p-tolylphosphine) dibromide;
palladium (II) bis(tri-p-tolylphosphine) diacetate;
palladium (II) bis(tri-p-tolylphosphine) bis(trifluoroacetate);
palladium (II) ethyl hexanoate;
bis(acetonato)palladium (II);
dichloro bis(benzonitrile)palladium (II);
n-butyldi-1-adamantylphosphine palladium diacetate(H₂O) (Pd601);
n-butyldi-tert-butylphosphine palladium diacetate(H₂O) (Pd445);
bis(n-butyl-di-1-adamantylphosphine) palladium acetate(acetonitrile) tetrakis(pentafluorophenyl)borate (Pdl602); and
(acetonitrile)bis(triisopropylphosphine)palladium(acetate)tetrakis(pentafluorophenyl) borate (Pd1206);
[(allyl)palladium(trinaphthylphosphine)(trifluoroacetate)];
[(allyl)palladium(trinaphthylphosphine)(trifluoromethanesulfonate)];
platinum (II) chloride;
platinum (II) bromide; and
platinum bis(triphenylphosphine)dichloride.

It is also well known in the art that such palladium compounds are further activated using a variety of activator compounds. Non-limiting examples of such activators may be selected from the group consisting of:
lithium tetrafluoroborate;
lithium triflate;
lithium tetrakis(pentafluorophenyl)borate;
lithium tetrakis(pentafluorophenyl)borate etherate (LiFABA);
sodium tetrakis(pentafluorophenyl)borate etherate (NaFABA);
trityl tetrakis(pentafluorophenyl)borate etherate (tritylFABA);
tropylium tetrakis(pentafluorophenyl)borate etherate (tropyliumFABA);
lithium tetrakis(pentafluorophenyl)borate isopropanolate;
lithium tetraphenylborate;
lithium tetrakis(3,5-bis(trifluoromethyl)phenyl)borate;
lithium tetrakis(2-fluorophenyl)borate;
lithium tetrakis(3-fluorophenyl)borate;
lithium tetrakis(4-fluorophenyl)borate;
lithium tetrakis(3,5-difluorophenyl)borate;
lithium hexafluorophosphate;
lithium hexaphenylphosphate;
lithium hexakis(pentafluorophenyl)phosphate;
lithium hexafluoroarsenate;
lithium hexaphenylarsenate;
lithium hexakis(pentafluorophenyl)arsenate;
lithium hexakis(3,5-bis(trifluoromethyl)phenyl)arsenate;
lithium hexafluoroantimonate;
lithium hexaphenylantimonate;
lithium hexakis(pentafluorophenyl)antimonate;
lithium hexakis(3,5-bis(trifluoromethyl)phenyl)antimonate;
lithium tetrakis(pentafluorophenyl)aluminate;
lithium tris(nonafluorobiphenyl)fluoroaluminate;
lithium (octyloxy)tris(pentafluorophenyl)aluminate;
lithium tetrakis(3,5-bis(trifluoromethyl)phenyl)aluminate;
lithium methyltris(pentafluorophenyl)aluminate; and
dimethylanilinium tetrakis(pentafluorophenyl)borate (DANFABA).

Generally, the polymerization is carried out in a suitable solvent and at a suitable temperature. Any of the solvents that can solubilize the palladium compounds and the monomers employed or miscible with the liquid monomers can be employed for this purpose. Suitable polymerization solvents include without any limitation, alkane and cycloalkane solvents, such as pentane, hexane, heptane, decalin, cyclohexane and methyl cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; ethers such as THF and diethylether; aromatic solvents such as benzene, xylene, toluene, mesitylene, chlorobenzene, and o-dichlorobenzene; and halocarbon solvents such as Freon® 112; ester solvents such as methyl acetate, ethyl acetate, butyl acetate and amyl acetate; and mixtures in any combination thereof.

Any of the temperature conditions that will bring about such polymerization can be used herein. In some embodiments, the polymer of this invention is formed by heating a mixture containing suitable amounts of monomers of formulae (I) and (II) in the presence of a palladium compound and the activator as described herein at a temperature in the range of about 60° C. to about 150° C. for a sufficient length of time, for example from about one hour to eight hours. In some other embodiments, the monomer mixture with the catalyst is heated to a temperature of about 90° C. to about 130° C. for a sufficient length of time, for example from about one hour to four hours to form the polymer of this invention. Further, the solution polymerization is carried out under an inert atmosphere, such as for example, under nitrogen, helium or argon atmosphere and using anhydrous solvents.

Advantageously, the vinyl addition polymer is formed from a palladium compound and monomers of formulae (I) and (II) with very high conversion at low (for example 8,000-15,000 to 1) catalyst loading, where the polymer's molecular weight is controlled using a chain transfer agent, such as, triethylsilane (TES). Various other chain transfer agents can also be used to control the molecular weight of the resulting polymer as described herein, including for example, bicyclo[4.2.0]oct-7-ene (BCO), formic acid, various other silanes, and the like, including mixtures in any combination thereof. Use of various CTAs in vinyl addition polymerization in order to control the resulting polymer properties is well known in the art. See, for example, U.S. Pat. No. 9,771,443 B2, pertinent portions of which are incorporated herein by reference.

The polymers formed according to this invention generally exhibit a weight average molecular weight (M_{w}) of at least about 1,000. In another embodiment, the polymer of this invention has a M_{w} of at least about 3,000, 5,000, 10,000 or 20,000. In another embodiment, the polymer of this invention has a M_{w} of at least about 50,000. In another embodiment, the polymer of this invention has a M_{w} of at least about 60,000. In another embodiment, the polymer of this invention has a M_{w} of at least about 70,000. In yet another embodiment, the polymer of this invention has a M_{w} of at least about 80,000. In some other embodiments, the polymer of this invention has a M_{w} of at least about 100,000. In another embodiment, the polymer of this invention has a M_{w} of higher than 150,000, higher than 200,000 and can be higher than 500,000 in some other embodiments. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards or polybutadiene (PBD) standards. The polymers of this invention typically exhibit polydispersity index (PDI) higher than 3, which is a ratio of weight average molecular weight (M_{w}) to number average molecular weight (Mₙ). In general, the PDI of the polymers of this invention ranges from 3 to 5. In some embodiments the PDI is higher than 3.5, higher than 4, higher than 4.5, or can be higher than 5. However, it should be noted that in some embodiments the PDI can be lower than 3, such as for example, 2.5.

The polymer thus formed is then used to make the compositions as described herein, which is used to produce composite materials having hitherto unattainable properties, such as for example, extremely low coefficient of thermal expansion (CTE), which can be as low as 100 ppm/° K, below 90 ppm/° K, 80 ppm/° K, 50 ppm/° K or lower than 40 ppm/° K. The polymer of this invention also exhibits extremely low dielectric constant as well as low loss properties. For example, dielectric constant (Dk) of the polymer of this invention can be as low as 2.8 or lower and can be in the range of from about 2.2 to about 3.2 at a frequency of 10 GHz. The low loss (Df) of the polymer can be lower than 0.0015, and may range from about 0.001 to 0.002. In addition, the polymer of this invention exhibits extremely high glass transition temperature (T_{g}), which can be higher than 250° C., and generally ranges from about 250° C. to 350° C. Even more importantly, the polymer of this invention readily binds with other crosslinkable materials as illustrated further below in various compositions made according to this invention. The compositions thus formed generally exhibit high peel strength, which could range as high as from 6 to 8 N/cm, thus finding many applications for example as copper clad laminates.

Accordingly, in a further aspect of this invention there is also provided a composition comprising:
a) a polymer made according to this invention;
b) a crosslinking agent selected from the group consisting of:

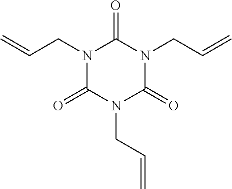 [SMILES: C=CCn1c(=O)n(CC=C)c(=O)n(CC=C)c1=O]

1,3,5-trial-1-1,3,5-triazinane-2,4,6-trione (TAIC);

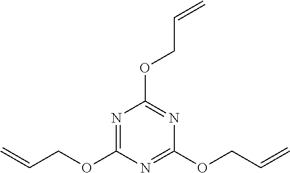 [SMILES: C=CCOc1nc(OCC=C)nc(OCC=C)n1]

2,4,6-tris(allyloxy)-1,3,5-triazine (TAC);
a compound of formula (III):

X-(A)ₚ (III)
wherein,
p is an integer from 2 to 6;
A is acrylate or methacylate;
X is selected from the group consisting of substituted or unsubstituted (C₁-C₁₆)alkyl, (C₃-C₁₆)cycloalkyl, (C₃-C₁₆)cycloalkyl(C₁-C₆)alkyl, (C₆-C₁₆)bicycloalkyl, (C₆-C₁₆)bicycloalkyl(C₁-C₆)alkyl, (C₈-C₁₆)tricycloalkyl and (C₈-C₁₆)tricycloalkyl(C₁-C₆)alkyl;
a compound of formula (IV):

Y—(B)_{q} (IV)
wherein,
q is an integer from 2 to 6;
B is a radical of formula (V):

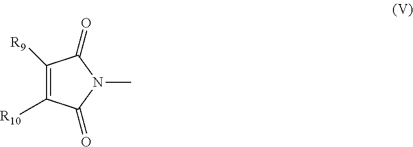

wherein R₉ and R₁₀ are the same or different and each independently selected from the group consisting of hydrogen, methyl, ethyl and linear or branched (C₃-C₆)alkyl;
Y is selected from the group consisting of substituted or unsubstituted (C₃-C₁₆)cycloalkyl, (C₃-C₁₆)cycloalkyl(C₁-C₆)alkyl, (C₆-C₁₆)bicycloalkyl, (C₆-C₁₆)bicycloalkyl(C₁-C₆)alkyl, (C₈-C₁₆)tricycloalkyl and (C₈-C₁₆)tricycloalkyl(C₁-C₆)alkyl; and
a mixture in any combination thereof; and
c) one or more additives selected from the group consisting of a tackifier and a free radical initiator.

As noted, any of the specific polymers within the general scope as described herein containing one or more monomers of formula (I) and at least one monomer of formula (II) can be employed in the composition of this invention. It should further be noted that the polymer contains at least four mole percent of repeat units of formula (IIA) derived from the corresponding monomer of formula (II) based on the total moles of repeat units of formulae (IA) and (IIA). In some embodiments, the composition of this invention contains a repeat units of formula (IIA) derived from the corresponding monomer of formula (II) in the amounts ranging from about five (5) mole percent to about forty (40) mole percent, from about ten (10) mole percent to about thirty (30) mole percent, from about fifteen (15) mole percent to about twenty-five (25) mole percent, and so on, based on total mole percent of repeat units of formulae (IA) and (IIA) present in the polymer. However, it should be noted that the polymer may contain lower than four (4) mole percent or higher than forty (40) mole of the repeat units of formula (IIA) depending upon the intended application of the composition so formed. Accordingly, all such possible combinations of mole percent of repeat units of formula (IIA) is within the scope of this invention.

Any of the compounds of formula (III) can be used in the composition of this invention. Non-limiting examples of specific compounds falling within the scope of formula (III) may be enumerated as follows:

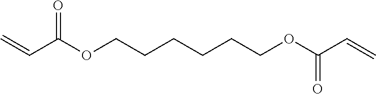 [SMILES: C=CC(=O)OCCCCCCOC(=O)C=C]

hexane-1,6-diyl diacrylate (Hex-diacrylate);

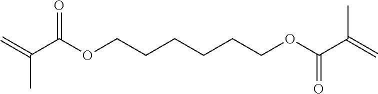 [SMILES: C=C(C)C(=O)OCCCCCCOC(=O)C(=C)C]

hexane-1,6-diyl bis(2-methylacrylate) (Hex-dimethacrylate);

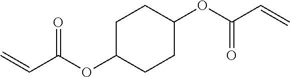 [SMILES: C=CC(=O)OC1CCC(OC(=O)C=C)CC1]

cyclohexane-1,4-diyl diacrylate (1,4-CyHex-diacrylate);

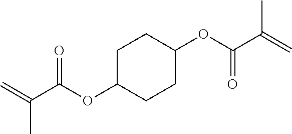 [SMILES: C=C(C)C(=O)OC1CCC(OC(=O)C(=C)C)CC1]

cyclohexane-1,4-diyl bis(2-methylacrylate) (1,4-CyHex-dimethacrylate);

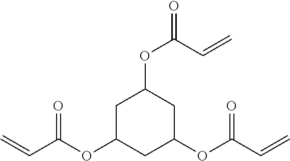 [SMILES: C=CC(=O)OC1CC(OC(=O)C=C)CC(OC(=O)C=C)C1]

cyclohexane-1,3,5-triyl triacrylate (1,3,6-CyHex-triacrylate);

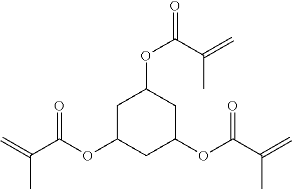 [SMILES: C=C(C)C(=O)OC1CC(OC(=O)C(=C)C)CC(OC(=O)C(=C)C)C1]

cyclohexane-1,3,5-triyl tris(2-methylacrylate) (1,3,5-CyHex-trimethacrylate);

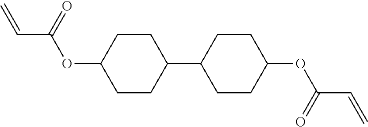 [SMILES: C=CC(=O)OC1CCC(C2CCC(OC(=O)C=C)CC2)CC1]

[1,1′-bi(cyclohexane)]-4,4′-diyl diacrylate (di-CyHex-diacrylate);

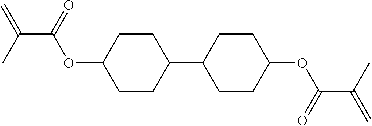 [SMILES: C=C(C)C(=O)OC1CCC(C2CCC(OC(=O)C(=C)C)CC2)CC1]

[1,1′-bi(cyclohexane)]-4,4′-diyl bis(2-methylacrylate) (di-CyHex-dimethacrylate);

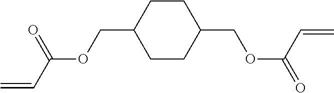 [SMILES: C=CC(=O)OCC1CCC(COC(=O)C=C)CC1]

cyclohexane-1,4-diylbis(methylene) diacrylate (1,4-CyHex(CH₂acrylate)₂);

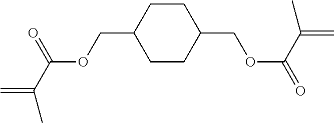 [SMILES: C=C(C)C(=O)OCC1CCC(COC(=O)C(=C)C)CC1]

cyclohexane-1,4-diylbis(methylene) bis(2-methylacrylate) (1,4-CyHex(CH₂methacrylate)₂);

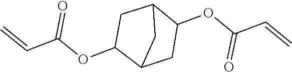 [SMILES: C=CC(=O)OC1CC2CC1CC2OC(=O)C=C]

bicyclo[2.2.1]heptane-2,5-diyl diacrylate (NB-diacrylate);

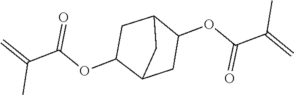 [SMILES: C=C(C)C(=O)OC1CC2CC1CC2OC(=O)C(=C)C]

bicyclo[2.2.1]heptane-2,5-diyl bis(2-methylacrylate) (NB-dimethacrylate);

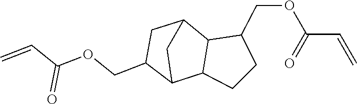 [SMILES: C=CC(=O)OCC1CC2CC1C1CCC(COC(=O)C=C)C21]

(octahydro-1H-4,7-methanoindene-1,5-diyl)bis(methylene) diacrylate (NB—CP(CH₂-acrylate)₂);

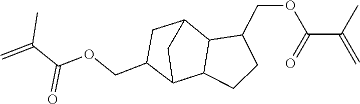 [SMILES: C=C(C)C(=O)OCC1CC2CC1C1CCC(COC(=O)C(=C)C)C21]

(octahydro-1H-4,7-methanoindene-1,5-diyl)bis(methylene) bis(2-methylacrylate) (NB—CP(CH₂-methacrylate)₂);

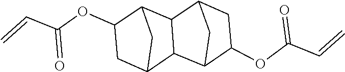 [SMILES: C=CC(=O)OC1CC2CC1C1C3CC(OC(=O)C=C)C(C3)C21]

decahydro-1,4:5,8-dimethanonaphthalene-2,6-diyl diacrylate (TD-diacrylate);

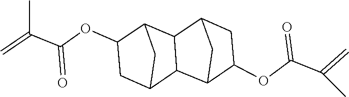 [SMILES: C=C(C)C(=O)OC1CC2CC1C1C3CC(OC(=O)C(=C)C)C(C3)C21]

decahydro-1,4:5,8-dimethanonaphthalene-2,6-diyl bis(2-methylacrylate) (TD-dimethacrylate); and

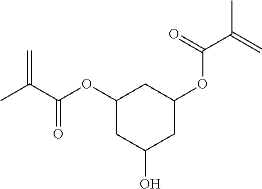 [SMILES: C=C(C)C(=O)OC1CC(O)CC(OC(=O)C(=C)C)C1]

5-hydroxycyclohexane-1,3-diyl bis(2-methylacrylate) (CyHex(OH)dimethacrylate).

Similarly, any of the compounds of formula (IV) can be used in the composition of this invention. The compounds of formula (IV) are either known in the art or can be prepared by any of the methods known in the art. One such method includes for example condensation of an amine with maleic anhydride to form desirable maleimides of formula (IV). Non-limiting examples of specific compounds falling within the scope of formula (IV) may be enumerated as follows:

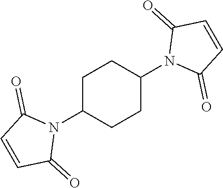 [SMILES: O=C1C=CC(=O)N1C1CCC(N2C(=O)C=CC2=O)CC1]

1,1′-(cyclohexane-1,4-diyl)bis(1H-pyrrole-2,5-dione) (1,4-CyHex(MI)₂);

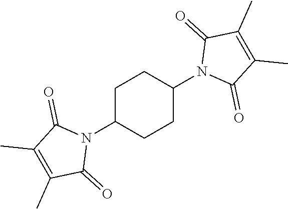

1,1′-(cyclohexane-1,4-diyl)bis(3,4-dimethyl-1H-pyrrole-2,5-dione) (CyHex(DMMI)₂);

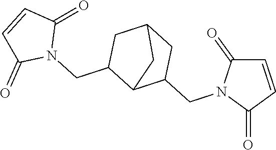 [SMILES: O=C1C=CC(=O)N1CC1CC2CC(CN3C(=O)C=CC3=O)C1C2]

1,1′-(bicyclo[2.2.1]heptane-2,6-diylbis(methylene))bis(1H-pyrrole-2,5-dione) (2,6-NB(CH₂-MI)₂)

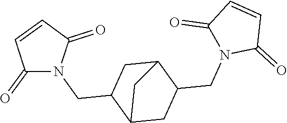 [SMILES: O=C1C=CC(=O)N1CC1CC2CC1CC2CN1C(=O)C=CC1=O]

1,1′-(bicyclo[2.2.1]heptane-2,5-diylbis(methylene))bis(1H-pyrrole-2,5-dione) (2,5-NB(CH₂-MI)₂);

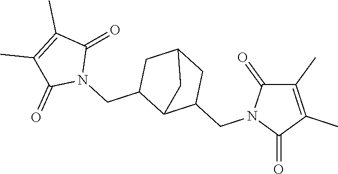

1,1′-(bicyclo[2.2.1]heptane-2,6-diylbis(methylene))bis(3,4-dimethyl-1H-pyrrole-2,5-dione) (2,6-NB(CH₂-DMMI)₂); and

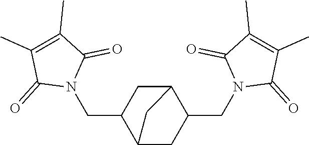

1,1′-(bicyclo[2.2.1]heptane-2,5-diylbis(methylene))bis(3,4-dimethyl-1H-pyrrole-2,5-dione) (2,5-NB(CH₂-DMMI)₂).

Any amount of the crosslinking agents can be used in the composition of this invention so as to bring about the intended benefit. Accordingly, in some embodiments the composition contains at least one crosslinking agent. In some other embodiments the composition contains two or more crosslinking agents. In yet some other embodiments the composition contains a mixture of one of TAIC or TAC and at least one of acrylate crosslinking agents. In yet some other embodiments the composition contains a mixture of one of TAIC or TAC and at least one of maleimide crosslinking agents. Generally, the amount of crosslinking agent used in the composition of this invention can range from about 5 to 20 parts per hundred parts of polymer (pphr), 8 to 18 pphr, 10 to 16 pphr, and so on. When a combination of two or more crosslinking agents are used in the composition the amounts of each can be same or different. The total amount of crosslinking agent may be around 10 to 30 pphr, 15 to 25 pphr, and so on. Again, it should be noted that such amounts can be higher or lower depending upon the intended use of the composition.

As noted, the composition according to this invention contains a tackifier. Generally, the purpose of the tackifier is not only to increase the adhesiveness of the composition but also to improve the softness of the composition especially while fabricating at temperatures higher than 130° C. so that the composition may have some flow to impregnate the glass cloth or to fuse with other layers of the device. The composition of this invention can generally be crosslinked at a temperature higher than 130° C., and it is beneficial to keep the composition soft at this temperature. Accordingly, any of the tackifiers that would bring about this benefit can be used in the compositions of this invention. In addition, the amount of tackifier used can also vary depending on the intended use. Generally, such amounts can range from about 5 to 30 parts per hundred parts of polymer (pphr), 8 to 25 pphr, 10 to 20 pphr, and so on. It should be noted that a combination of two or more tackifiers can also be used in the composition of this invention. In such situations the combined amount can be adjusted in order to provide the intended benefit.

Non-limiting examples of such tackifiers that are suitable in the composition of this may be enumerated as follows:

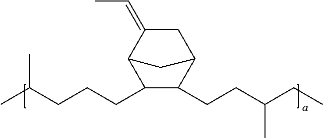

ethylene-propylene-ethylidenenorbornene terpolymer, where a is at least 100 (commercially available as TRILENE® T67 from Lion Elastomers);

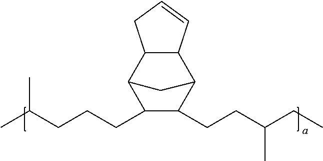

ethylene-propylene-dicyclopentadiene terpolymer, where a is at least 100 (commercially available as TRILENE® T65 from Lion Elastomers);

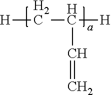

1,2-butadiene rubber, where a is at least 100 (commercially available as B1000 from Nisso America);

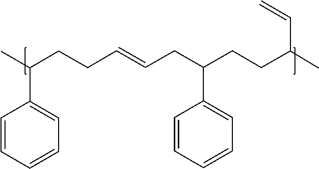

partially hydrogenated styrene/butadiene rubber 1 (commercially available from Asahi Kasei as Tuftec P1083);

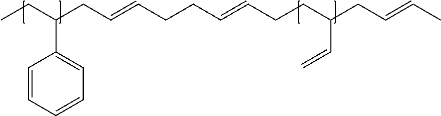

partially hydrogenated styrene/butadiene rubber 2 (commercially available from Asahi Kasei as Tuftec 1500);

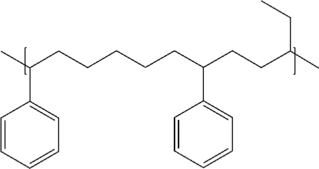

hydrogenated styrene/butadiene rubber 1 (commercially available from Asahi Kasei as Tuftec H 1052); and

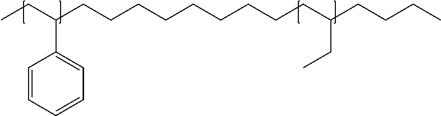

hydrogenated styrene/butadiene rubber 2.

As noted, the composition of this invention further contains a free radical generator. Any free radical generator which will bring about the crosslinking reaction with the polymer and other components present in the composition and which facilitates adhesion to other suitable substrate such as for example copper and/or glass cloth can be used in the composition of this invention. Again, any amount of free radical generator can be used which will bring about the intended benefit. Such amounts may vary and for example can range from about 1 pphr to 6 pphr of the free radical initiator.

Non-limiting examples of the free radical generator that can be used in the composition of this invention include the following:

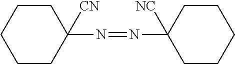 [SMILES: N#CC1(N=NC2(C#N)CCCCC2)CCCCC1]

1,1′-(diazene-1,2-diyl)bis(cyclohexane-1-carbonitrile) (commercially available as V-40 from Sigma Aldrich);

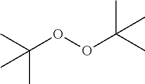

di-tert-butyl peroxide;

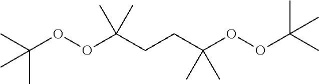 [SMILES: CC(C)(C)OOC(C)(C)CCC(C)(C)OOC(C)(C)C]

2,5-bis(tert-butylperoxy)-2,5-dimethylhexane (Luperox-101);

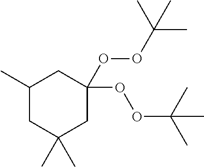 [SMILES: CC1CC(C)(C)CC(OOC(C)(C)C)(OOC(C)(C)C)C1]

1,1-bis(tert-butylperoxy)-3,3,5-trimethylcyclohexane (Luperox-231);

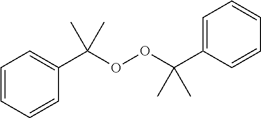 [SMILES: CC(C)(OOC(C)(C)c1ccccc1)c1ccccc1]

dicumyl peroxide (DCP, commercially available from Sigma Aldrich);

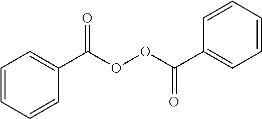 [SMILES: O=C(OOC(=O)c1ccccc1)c1ccccc1]

benzoyl peroxide;

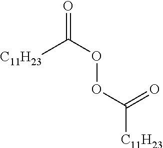

dodecanoic peroxyanhydride (Luperox-LP);

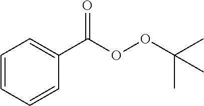

tert-butyl benzoperoxoate (Luperox-P); and

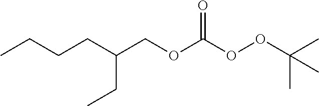 [SMILES: CCCCC(CC)COC(=O)OOC(C)(C)C]

tert-butyl (2-ethylhexyl) carbonoperoxoate (Luperox-TBEC).

As noted, any of the polymers as described herein can be employed in the composition of this invention. Generally, the composition of this invention is dissolved in a suitable solvent to form a homogeneous solution. Such suitable solvents may be the same as the one enumerated above for forming the polymers of this invention. Generally, such solvents to form the composition of this invention include for example, aromatic solvents such as toluene, mesitylene, xylenes, hydrocarbon solvents such as decalin, cyclohexane and methyl cyclohexane, ether solvent such as tetrahydrofuran (THF), ester solvent such as ethyl acetate, and a mixture in any combination thereof.

Non-limiting examples of the composition according to this invention are selected from the group consisting of:
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); and dicumyl peroxide (DCP);
a solution containing a mixture of a tetrapolymer of norbornene (NB), 5-hexylbicyclo[2.2.1]hept-2-ene (HexNB), 5-cyclohexylbicyclo[2.2.1]hept-2-ene (CyHexaneNB) and bicyclo[2.2.1]hept-5-en-2-yl methacrylate (NB-methacrylate); 1,2-butadiene rubber (B1000), ethylene-propylene-ethylidenenorbornene terpolymer (T67), 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,2-butadiene rubber (B1000), ethylene-propylene-ethylidenenorbornene terpolymer (T67), 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); cyclohexane-1,4-diyl bis(2-methylacrylate) (1,4-CyHex-dimethacrylate), 1,2-butadiene rubber (B1000), ethylene-propylene-ethylidenenorbornene terpolymer (T67), 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,3,5-CyHex(trimethacrylate), 1,2-butadiene rubber (B1000), ethylene-propylene-ethylidenenorbornene terpolymer (T67), 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,1′-(bicyclo[2.2.1]heptane-2,5-diylbis(methylene))bis(3,4-dimethyl-1H-pyrrole-2,5-dione) (2,5-NB(CH₂-DMMI)₂) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,1′-(bicyclo[2.2.1]heptane-2,5-diylbis(methylene))bis(3,4-dimethyl-1H-pyrrole-2,5-dione) (2,5-NB(CH₂-DMMI)₂), ethylene-propylene-ethylidenenorbornene terpolymer (T67) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber (B1000) and dicumyl peroxide (DCP);
a solution containing a mixture of a terpolymer of norbornene (NB), 5-hexylbicyclo[2.2.1]hept-2-ene (HexNB) and 5-(but-3-en-1-yl)bicyclo[2.2.1]hept-2-ene (ButenylNB); cyclohexane-1,4-diyl bis(2-methylacrylate) (1,4-CyHex-dimethacrylate), 1,2-butadiene rubber (B1000) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber (B1000), ethylene-propylene-ethylidenenorbornene terpolymer (T67), (NB-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber (B1000), ethylene-propylene-ethylidenenorbornene terpolymer (T67), (di-CyHex-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,4-CyHex(MI)₂ and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,1′-(bicyclo[2.2.1]heptane-2,5-diylbis(methylene))bis(3,4-dimethyl-1H-pyrrole-2,5-dione) (2,5-NB(CH₂-DMMI)₂) and dicumyl peroxide (DCP); and

a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,1′-(bicyclo[2.2.1]heptane-2,5-diylbis(methylene))bis(3,4-dimethyl-1H-pyrrole-2,5-dione) (2,5-NB(CH₂-DMMI)₂), ethylene-propylene-ethylidenenorbornene terpolymer (T67) and dicumyl peroxide (DCP).

In general, the composition in accordance with the present invention encompass a polymer as described herein containing one or more distinct monomers of formula (I), and at least one monomer of formula (II) in small quantities, as it will be seen below, various composition embodiments are selected to provide properties to such embodiments that are appropriate and desirable for the use for which such embodiments are directed, thus such embodiments are tailorable to a variety of specific applications. Accordingly, in some embodiments the composition of this invention encompasses a polymer containing more than two distinct monomers of formula (I), such as for example, three different monomers of formula (I) or four different monomers of formula (I) along with any desirable amount of monomer of formula (II), which can be as low as four mole percent as noted above.

For example, as already discussed above, by employing proper combination of different monomers of formula (I) it is now possible to tailor a composition having the desirable low dielectric properties and thermo-mechanical properties, among other properties. In addition, it may be desirable to include other polymeric or monomeric materials which are compatible to provide desirable low-loss and low dielectric properties depending upon the end use application as further discussed in detail below.

Even more advantageously, it has now been found that employing at least one monomer of formula (II), surprisingly, even in small amounts it is now possible to form crosslink structures within the polymeric framework in combination with the crosslinking agent as described herein. That is, crosslinks can occur inter-molecular (i.e., between two cross-linkable sites on different polymer chains as well as intra-molecular (i.e., between two cross-linkable sites on the same polymer chain). Statistically, this can happen, and all such combinations are part of this invention. By forming such inter-molecular or intra-molecular crosslinks the polymers formed from the composition of this invention provide hitherto unobtainable properties. This may include for example improved thermal properties. That is, much higher glass transition temperatures than observed for non-crosslinked polymers of similar composition. In addition, such crosslinked polymers are more stable at higher temperatures, which can be higher than 350° C. High temperature stability can also be measured by well-known thermogravimetric analysis (TGA) methods known in the art. One such measurement includes a temperature at which the polymer loses five percent of its weight (T_{d5}). As will be seen below by specific examples that follow the T_{d5} of the polymers formed from the composition of this invention can generally be in the range from about 330° C. to about 380° C. or higher. In some embodiments, the T_{d5} of the polymers formed from the composition of this invention is in the range from about 350° C. to about 375° C.

The compositions in accordance with the present invention may further contain optional additives as may be useful for the purpose of improving properties of both the composition and the resulting object made therefrom. Such optional additives for example may include anti-oxidants and synergists. Any of the anti-oxidants that would bring about the intended benefit can be used in the compositions of this invention. Non-limiting examples of such antioxidants include pentaerythritol tetrakis(3-(3,5-di-tert-butyl-4-hydroxyphenyl)propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl)propionate] (IRGANOX™ 1035 from BASF). Non-limiting examples of such synergists include certain of the secondary antioxidants which may provide additional benefits such as for example prevention of autoxidation and thereby degradation of the composition of this invention and extending the performance of primary antioxidants, among other benefits. Examples of such synergists include, tris(2,4-ditert-butylphenyl)phosphite, commercially available as IRGAFOS 168 from BASF, various diamine synergists such as for example, N,N′-di-2-naphthyl-1,4-phenylenediamine, among others. Another synergist which may be suitable as an additive in the composition of this include certain diesters, such as for example, didodecyl 3,3′-thiodipropionate, whose structure is shown below:

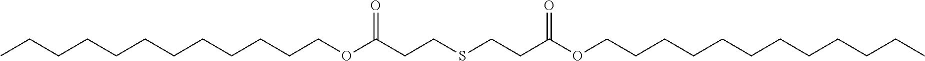 [SMILES: CCCCCCCCCCCCOC(=O)CCSCCC(=O)OCCCCCCCCCCCC]

### didodecyl 3,3′-thiodipropionate (TDPDLE)

It has further been found that the monomers of formulae (I) or (II) also undergo mass polymerization under certain conditions in the presence of palladium catalysts and the activator compounds as described herein to form a three dimensional object such as films. Thus, it is advantageous to use monomers of formulae (I) or (II) as such without first converting them into a polymer to form the compositions suitable in a variety of applications as contemplated herein in certain situations.

Accordingly, there is further provided a film forming composition comprising:
a) one or more olefinic monomers of formula (I) as described herein;
b) optionally a monomer of formula (II) as described herein;
c) an organopalladium compound as described herein;
d) an activator as described herein;
e) a crosslinking agent as described herein; and
f) one or more additives selected from the group consisting of a tackifier and a free radical initiator as described herein;
with the proviso that when a monomer of formula (II) is absent then the composition contains at least one compound of formula (III) or one compound of formula (IV); and
wherein the film formed from the composition has a dielectric constant (Dk) less than 2.4 at a frequency of 10 GHz, a glass transition temperature greater than 200° C. and a coefficient of thermal expansion (CTE) less than 180 ppm/K.

Any one or more of the monomers of formula (I) as described herein can be used in the composition in suitable quantities as required for the intended applications. Similarly, any one of the monomers of formula (II) as described herein can be used, if needed, in the composition of this invention. Likewise, any of the crosslinking agents as described herein, including TAIC, TAC and any of the compounds of formulae (III) or (IV) can be used in this composition. However, as noted, when a monomer of formula (II) is not used in the composition of this invention, then at least one compound of formula (III) or one compound of formula (IV) must be used to obtain the intended benefit. Further, it should be noted that mixture of crosslinking agents in any combination can be used in this composition. Finally, any of the tackifiers and the free radical generators as described herein can be used in this aspect of the composition of this invention.

Advantageously, the composition as described herein undergoes mass polymerization when subjected to suitable temperature conditions to form a solid object, such as for example, a film. Any of the temperature conditions that will bring about such a mass polymerization can be used herein. In some embodiments, the composition of this invention is heated to a temperature of about 60° C. to about 150° C. for a sufficient length of time, for example from about one hour to eight hours to form B-stage films. In some other embodiments, the composition of this invention is heated to a temperature of about 90° C. to about 130° C. for a sufficient length of time, for example from about one hour to four hours to form B-stage films. The B-staged films are then further heated to higher temperatures, for example from about 150° C. to about 200° C. to form fully cured films.

In most cases the organopalladium compound and the activator employed to affect the mass polymerization as well as the crosslinking agent and the tackifier maybe soluble in the monomers employed so as to form a homogeneous solution. If not, the organopalladium compound and the activator can be dissolved in a suitable solvent, such as for example, tetrahydrofuran (THF) and then mixed with one or more monomers of formula (I), a monomer of formula (II), if employed, the crosslinking agent(s), the tackifiers and the free radical generator to form a homogeneous solution. Other solvents that can be used to solubilize the organopalladium compound and/or the activator as described herein include ethyl acetate (EA), toluene, trifluorotoluene (TFT), cyclohexane (CH), methylcyclohexane (MCH), and the like. Although mass polymerization of the composition in the presence of a combination of several components as described herein are unknown in the art mass polymerization methods are however known in the art and such modified procedures as is suitable can be employed herein to form the films of this invention. See for instance, U.S. Pat. No. 6,825,307, pertinent portions of which are incorporated herein by reference.

Non-limiting examples of mass polymerizable film forming composition according to this invention is selected from the group consisting of:
a mixture of 5-hexylbicyclo[2.2.1]hept-2-ene (HexNB), bicyclo[2.2.1]hept-5-en-2-yl methacrylate (NB-methacrylate), 5-bis(1,1-dimethylethyl)-4-hydroxy-octadecyl ester benzenepropanoic acid (Irganox-1076), tris(2,4-ditert-butylphenyl)phosphite (Irgafos-168), palladium (II) bis(tricyclohexylphosphine) diacetate (Pd785), dimethylanilinium tetrakis(pentafluorophenyl)borate (DANFABA);
a mixture of 5-hexylbicyclo[2.2.1]hept-2-ene (HexNB), bicyclo[2.2.1]hept-5-en-2-yl methacrylate (NB-methacrylate), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-(but-3-en-1-yl)bicyclo[2.2.1]hept-2-ene (ButenylNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-(cyclohex-3-en-1-yl)bicyclo[2.2.1]hept-2-ene (CyHexeneNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-cyclohexylbicyclo[2.2.1]hept-2-ene (CyHexaneNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), 5-(cyclohex-3-en-1-yl)bicyclo[2.2.1]hept-2-ene (CyHexeneNB), (octahydro-1H-4,7-methanoindene-1,5-diyl)bis(methylene) bis(2-methylacrylate) (NB—CP(CH₂-methacrylate)₂), palladium (II) bis(tricyclohexylphosphine) diacetate (Pd785), dimethylanilinium tetrakis(pentafluorophenyl)borate (DANFABA) and dicumyl peroxide (DCP); and
a mixture of 5-hexylbicyclo[2.2.1]hept-2-ene (HexNB), 5-(cyclohex-3-en-1-yl)bicyclo[2.2.1]hept-2-ene (CyHexeneNB), palladium (II) bis(tricyclohexylphosphine) diacetate (Pd785), dimethylanilinium tetrakis(pentafluorophenyl)borate (DANFABA), cyclohexane-1,4-diyl bis(2-methylacrylate) (1,4-CyHex-dimethacrylate), di-tert-butyl peroxide (DTBP) or di-cumyl peroxide (DCP).

Accordingly, either one of the compositions of this invention as described herein can be formed into films simply by following any of the known film casting techniques, including, for example, doctor blading, drum rolling, extrusion and/or spin coating, among other known methods. Accordingly, there is further provided a film formed from either of the compositions of this invention. For example, any of the composition of this invention can be doctor-bladed onto a suitable substrate such as for example a glass plate. The coated plate is then heated to suitable temperature in an inert atmosphere to remove any residual solvent. Such temperatures can range from about 80° C. to 150° C. or 120° C. to 140° C. Suitable inert atmosphere can be nitrogen or argon. The heating at these temperatures for sufficient length of time will remove all of the residual solvent, for example a time interval of about 45 minutes to about 75 minutes. This initial stage of film forming is generally called as B-staged films. Under these conditions the film is still soluble in a suitable solvent such as for example THF, and is not fully crosslinked. The B-staged films are then further heated to higher temperature, which can range from about 150° C. to 220° C. or 160° C. to 190° C. in an inert atmosphere for sufficient length of time in order to affect the crosslinking of the film. Generally, such heating is carried out for about 90 minutes to 180 minutes to ensure full crosslinking of the composition, which is confirmed by insolubility of the polymer film.

The film thus formed in accordance with this invention exhibits unusually low dielectric constant, low loss, low coefficient of thermal expansion (CTE) and high glass transition temperature. In some embodiments the film formed according to this invention exhibits a dielectric constant (Dk) less than 3, less than 2.8, less than 2.6, less than 2.5, less than 2.4, less than 2.3, less than 2.2 at a frequency of 10 GHz, a glass transition temperature (T_{g}) in the range from about 150° C. to 280° C. or higher. In some other embodiments the T_{g} can be higher than 150° C., higher than 200° C., higher than 250° C. In yet some other embodiments the film according to this invention exhibits coefficient of thermal expansion (CTE) in the range of from about 80 ppm/K to 120 ppm/K, and a CTE less than 50 ppm/K when composited with glass cloth.

The film according to this invention can be formed from any of the specific embodiment of the composition as enumerated hereinabove. In a further aspect of this invention there is also provided a film formed from the polymer of this invention.

In a further embodiment, the film according to this invention exhibits a dielectric constant (Dk) less than 3 at a frequency of 10 GHz, a glass transition temperature higher than 150° C. and a coefficient of thermal expansion (CTE) less than 50 ppm/K.

It should additionally be noted that the crosslinked polymers formed from the composition of this invention may form thermosets thus offering additional advantages especially in certain applications where thermoplastics are not desirable. For example, any of the applications where higher temperatures are involved the thermoplastic polymers become less desirable as such polymeric materials may flow and are not suitable for such high temperature applications. Such applications include millimeter wave radar antennas as contemplated herein, among other applications.

Advantageously, it has further been found that the low dielectric properties of the films formed from the composition of this invention can be improved by incorporating one or more filler materials. The filler materials can either be organic or inorganic. Any of the known filler materials which bring about the intended benefit can be used herein.

Accordingly, in some embodiments, the film forming composition according to this invention comprises an inorganic filler. Suitable inorganic filler is the one which has a coefficient of thermal expansion (CTE) lower than that of the film formed from the composition of this invention. Non-limiting examples of such inorganic filler includes oxides such as silica, alumina, diatomaceous earth, titanium oxide, iron oxide, zinc oxide, magnesium oxide, metallic ferrite; hydroxides such as aluminum hydroxide, magnesium hydroxide; calcium carbonate (light and heavy); magnesium carbonate, dolomite; carbonates; sulfates such as calcium sulfate, barium sulfate, ammonium sulfate, and calcium sulfite; talc, mica; clay; glass fibers; calcium silicate; montmorillonite; silicates such as bentonite; borates such as zinc borate, barium metaborate, aluminum borate, calcium borate, and sodium borate; carbon black; carbon such as carbon fibers; iron powder; copper powder; aluminum powder; zinc oxide; molybdenum sulfide; boronic fibers; potassium titanate; and lead zirconate. Various inorganic filler materials are commercially available, for example, silica nano particles are available as SC2300-SVJ from Adamatech Co. Ltd., and a ceramic filler, Lithafrax-2121, is available from St. Gobain, among many other filler materials that may be suitable for using with the composition of this invention.

In some other embodiments the film forming composition according to this invention further comprises an organic filler, which is generally a synthetic resin maybe in the form of a powder or can be in any other suitable form or a polymer. Examples of such polymeric fillers include without any limitation, poly(α-methylstyrene), poly(vinyl-toluene), copolymers of α-methylstyrene and vinyl-toluene, and the like. Further examples of such synthetic resin powder include powders of various thermosetting resins or thermoplastic resins such as alkyd resins, epoxy resins, silicone resins, phenolic resins, polyesters, acrylic and methacrylic resins, acetal resins, polyethylene, polyethers, polycarbonates, polyamides, polysulfones, polystyrenes, polyvinyl chlorides, fluororesins, polypropylene, ethylene-vinyl acetate copolymers, melamine, and powders of copolymers of these resins. Other examples of the organic filler include aromatic or aliphatic polyamide fibers, polypropylene fibers, polyester fibers, aramid fibers, and the like.

In some embodiments the filler is an inorganic filler. Thus, the coefficient of thermal expansion can be effectively reduced. Further, heat resistance can be improved. Accordingly, in some embodiments the inorganic filler is silica. Thus, the thermal expansion coefficient can be reduced while the dielectric characteristic is improved. Various forms of silica fillers are known in the art and all of such suitable silica fillers can be used in the composition of this invention. Examples of such silica filler include without any limitation fused silica, including fused spherical silica and fused crushed silica, crystalline silica, silica nano particles, and the like. In some embodiments the filler employed is silica nano particles. Surprisingly, it has now been observed that by employing suitable amounts of silica nano particles it is now possible to form composition which exhibits very low dielectric constant and very low loss properties. In some embodiments, by employing suitable silica nanoparticles in the amounts of about 60 pphr to 80 pphr, the dielectric constant (Dk) can be reduced to as low as 2.25 or lower and low loss (Df) of about 0.0009. In some other embodiments the Dk is 2.3 and Df is about 0.001. Generally, the amount of filler material can vary from about 5 weight percent to 80 weight percent or higher. In some embodiments, the content of the filler in the composition is from about 30 to 80 weight percent, based on the total solid content of the composition when polymerized to form film/sheet as described herein. By appropriately adjusting the content of the filler, the balance between the dielectric property and the coefficient of thermal expansion (CTE) can be improved. In some other embodiments, the content of the filler in the composition is from about 40 to 70 weight percent, based on the total solid content of the composition.

Further, the composition according to this invention can also contain fillers such as hexagonal boron nitride (h-BN). It is generally known that incorporation of h-BN having suitable particle size may not only improve high thermal properties needed for various applications but also may improve the peel strength when applied to metal substrates such as copper, thus providing additional advantage in a variety of applications where copper clad laminates are employed, such as for example, printed circuit boards, mm-Wave Radar Antenna, and the like.

It should further be noted that the low dielectric properties of the films formed from the composition of this invention can be improved by incorporating h-BN. That is, the compositions of this invention may exhibit lower dielectric constant (Dk) and lower dissipation factor (Df) when appropriate amounts of h-BN is used in the composition of this invention. Generally, the boron nitride employed in the composition of this invention is in the form of hexagonal crystal structure. It is well known in the art that h-BN is available in the form of a powder, which includes flakes, platelets, and other shapes. In some embodiments the h-BN employed in the composition of this invention is in the form of platelets. The exact shape of the platelets is not critical. In this regard, h-BN platelets can have irregular shapes. As used herein, the term “platelets” is generally descriptive of any thin, flattened particles, inclusive of flakes. However, other forms of h-BN can also be used, which include fibers, rods, whiskers, sheets, nanosheets, agglomerates, or boron nitride nanotubes, and can vary as to crystalline type, shape, or size, and including a distribution of the foregoing. The h-BN particles can have an average aspect ratio (the ratio of width or diameter to length of a particle) of 1:2 to 1:100,000, or 1:5 to 1:1,000, or 1:10 to 1:300. Exemplary shapes of particles having particularly high aspect ratios include platelets, rod-like particles, fibers, whiskers, and the like. The platelets can have an average aspect ratio (the ratio of width to length of a particle) of 4:5 to 1:300, or 1:2 to 1:300, or 1:2 to 1:200, or 3:5 to 1:100, or 1:25 to 1:100.

It should further be noted that other forms of boron nitride can also be used in the composition of this invention, which include cubic, wurtzite, rhombohedral, or other synthetic structure. H—BN has a layered structure, analogous to graphite, in which the layers are stacked in registration such that the hexagonal rings in layers coincide. The positions of N and B atoms alternate from layer to layer. The h-BN particles can be obtained from a variety of commercial sources. Boron nitride particles, crystalline or partially crystalline, can be made by processes known in the art. These include, for example, boron nitride powder produced from the pressing process disclosed in U.S. Pat. Nos. 5,898,009 and 6,048,511, the boron nitride agglomerated powder disclosed in U.S. Patent Publication No. 2005/0041373. A variety of boron nitride powders are commercially available, for example, from St. Gobain.

Generally, the particle size distribution of h-BN can vary significantly and lower the particle size better it is to form homogeneous composition of this invention. Accordingly, in some embodiments the average particle size of h-BN if employed is less than 0.05 micrometer (i.e., less than 50 nanometers). In some other embodiments the average particle size of h-BN if employed is in the range of from about 0.05 micrometer to about 70 micrometer. In yet some other embodiments the average particle size of h-BN if employed is in the range of from about 0.1 micrometer to about 30 micrometer; 0.1 micrometer to about 20 micrometer; 0.1 micrometer to about 20 micrometer, and so on.

Any amount of h-BN can be used which will bring about the intended benefit and depending upon the end application of the composition. For example, by suitable amounts of incorporation of h-BN into the composition of this invention it is now possible to obtain not only excellent dielectric and low loss properties as well as very high thermal properties. In addition, it should be noted that h-BN not only acts as an insulating material in various electronic applications but also provides an excellent thermal conductivity and the heat is dissipated faster than the conventional insulating materials, thus composition of this invention are especially suitable for fabricating micro-electronic devices where heat is generated and needs to be dissipated, such as for example mm-Wave Radar Antenna, among others. Generally, boron nitride exhibits good thermal conductivity, and found to have one of the highest thermal conductivity coefficients in certain forms (as high as 751 W/mK at room temperature) among semiconductors and electrical insulators, and its thermal conductivity increases with reduced thickness due to less intra-layer coupling. For comparison, the thermal conductivity of silica particles is around 1.3 W/mK at room temperature. Therefore, depending upon the type of h-BN used and depending upon the amount of h-BN used in the composition of this invention it is now possible to tailor compositions having very high thermal conductivity. The thermal conductivity can be measured by any of the methods known in the art, such as for example, procedures as set forth in ASTM D5470-17, using a TIM Tester 1300.

In some embodiments the amount of h-BN employed in the composition of this invention is at least 20 weight percent based on the amount of the polymer employed in the composition. In some other embodiments the amount of h-BN present in the composition of this invention is at an amount in the range of from about 25 weight percent to about 120 weight percent based on the amount of the polymer. In yet other embodiments such amounts can vary from about 30 weight percent to about 100 weight percent, from about 40 weight percent to about 80 weight percent, from about 50 weight percent to about 70 weight percent, and so on, based on the amount of the polymer employed in the composition. However, it should be noted that lower than 20 weight percent or higher than 120 weight percent of h-BN, based on the polymer used, can also be employed in the composition of this invention where there is such need in fabricating suitable devices.

In general, the filler is treated with a silane compound having an alkoxysilyl group and an organic functional group such as an alkyl group, an epoxy group, a vinyl group, a phenyl group and a styryl group in one molecule. Such silane compounds include, for example, a silane having an alkyl group such as ethyltriethoxysilane, propyltriethoxysilane or butyltriethoxysilane (alkylsilane), a silane having a phenyl group such as phenyltriethoxysilane, benzyltriethoxysilane or phenethyltriethoxysilane, a silane having a styryl group such as styryltrimethoxysilane, butenyltriethoxysilane, propenyltriethoxysilane or vinyltrimethoxysilane (vinylsilane), a silane having an acrylic or methacrylic group such as γ-(methacryloxypropyl) trimethoxysilane, a silane having an amino group such as γ-aminopropyltriethoxysilane, N-β (aminoethyl)-γ-aminopropyltrimethoxysilane, N-phenyl-γ-aminopropyltrimethoxysilane or an epoxy group such as γ-(3,4-epoxycyclohexyl) ureido triethoxysilane, and the like. Silanes having a mercapto group such as γ-mercaptopropyltrimethoxysilane or the like can also be used. It should further be noted that one or more of the aforementioned silane compounds can be used in any combination.

It should further be noted that, when an inorganic filler is used as the filler, the filler is generally treated with a “nonpolar silane compound.” Thus, the adhesion between the cyclic olefin polymer formed from the composition of this invention and the filler can be improved. As a result, the mechanical characteristics of the molded body can be improved. Advantageously, it has now been observed that treatment with a “nonpolar silane compound” can eliminate or reduce adverse effects on dielectric properties. As used herein, “nonpolar silane compound” refers to a silane compound having no polar substituent. Polar substituents refer to groups that can be hydrogen-bonded or ionically dissociated. Such polar substituents include, but are not limited to, —OH, —COOH, —COOM, NH₃, NR₄⁺A⁻, —CONH₂, and the like. Where, M is a cation such as an alkali metal, an alkaline earth metal or a quaternary ammonium salt, R is H or an alkyl group having 8 or less carbon atoms, and A is an anion such as a halogen atom.

In some embodiments, the surface of the filler is modified with a vinyl group. It is advantageous to employ a vinyl group as it is a non-polar substituent, thus providing much needed low dielectric properties. In order to modify the surface of the filler with a vinyl group, for example, vinylsilane can be used. Specific examples of the vinylsilane are as described hereinabove.

In general, the average particle size of the filler used is in the range from about 0.1 to 10 μm. In some embodiments, it is from about 0.3 to 5 μm, and in some other embodiments it is from about 0.5 to 3 μm. The average particle size is defined as the average diameter of the particles as measured by the light scattering method. When more than one type of filler is used, the average particle diameter of one or more of such fillers is still within the aforementioned numerical range. Since the average particle diameter of the filler is suitably small, the specific surface area of the filler is reduced. As a result, the number of polar functional groups which may adversely affect the dielectric properties is reduced, and the dielectric properties are easily improved. In addition, when the average particle diameter of the filler is suitably small, it is easy to polymerize and form the films from the composition of this invention. Even more importantly, the films/sheets so formed exhibit much needed uniform thickness and flatness as is needed in many of the intended applications.

The composition of the present invention may contain components other than those described above. The components other than the above include a coupling agent, a flame retardant, a release agent, an antioxidant, and the like. Non-limiting examples of the coupling agent include, silane coupling agents, such as, vinylsilanes, acrylic and methacrylic silanes, styrylsilanes, isocyanatosilanes, and the like. Adhesion between the composition of this invention and a base material or the like can be improved by using a silane coupling agent.

Non-limiting examples of the flame retardant include a phosphorus-based flame retardant such as trixylenyl phosphate, dixylenyl phosphate, 10-(2,5-dihydroxyphenyl)-10H-9-oxa-10 phosphaphenanthrene-10-oxide, a halogen-based flame retardant such as a brominated epoxy resin, melamine formaldehyde resins, and an inorganic flame retardant such as aluminum hydroxide and magnesium hydroxide.

The composition of this invention may further include one or more compounds or additives having utility as, among other things, adhesion promoter, a surface leveling agent, a synergist, plasticizers, curing accelerators, and the like.

Surprisingly, it has now been found that employing one or more thermal free radical initiator as described herein it is now possible to accelerate the crosslinking of the polymer formed from the composition of this invention, resulting in a crosslinked polymer that exhibits much improved thermal properties. For example, both glass transition temperature (T_{g}) and temperature at which five weight percent weight loss occurs (T_{d5}) of the resulting polymer can be increased. Such increase in T_{g} can be substantial and can range from about 10° C. to 50° C. In some embodiments the T_{g} of the polymer is increased from 20° C. to 40° C. by employing suitable amounts of thermal free radical initiator. Similarly, the T_{d5} of the polymer can also be increased from about 3° C. to 10° C.

It should be noted that the composition of this invention can be formed into any shape or form and not particularly limited to film. Accordingly, in some embodiments the composition of this invention can be formed into a sheet. The thickness of the sheet is not particularly limited, but when the application as a dielectric material is considered, the thickness is, for example, 0.01 to 0.5 mm. In some other embodiments the thickness is from about 0.02 to 0.2 mm. The sheet so formed generally does not substantially flow at room temperature (25° C.). The sheet may be provided on an arbitrary carrier layer or may be provided alone. Examples of the carrier layer include a polyimide film or a glass sheet. Any other known peelable film substrates may be used as the carrier layer.

As described above, the film/sheet formed in accordance with this invention has good dielectric properties and can be tailored based on the types of components employed in the composition of this invention as described herein. In quantitative terms, the relative permittivity, i.e., the dielectric constant (Dk) of the film/sheet at a frequency of 10 GHz is from about 2.2 to 2.4. The dielectric loss tangent (Df) at a frequency of 10 GHz is from about 0.0004 to 0.002, and in some other embodiments it is from about 0.0009 to 0.0015. As a result, the composition of the present invention finds applications in a variety of devices where such low dielectric materials are needed, such as for example, the dielectric polymeric layers used in the millimeter wave radar antenna used in automotive applications and various other terminal equipment used in 5G devices, among others. See for example, JP 2018-109090 and JP 2003-216823. An antenna is usually composed of an insulator and a conductor layer (for example, copper foil). The composition or sheet of the present invention can be used as a part or the whole of the insulator. The antenna using the composition or the sheet of the present invention as a part or the whole of the insulator has good high-frequency characteristics and reliability (durability). The use of such materials in printed circuit boards as Cu-clad laminates need high performance thermosets having high glass transition temperatures, low coefficients of thermal expansion (CTE), low Dk/Df, high peel strength on Cu and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in this area have not attained all these properties, especially low Dk/Df and high glass transition temperature.

The conductor layer in the antenna is formed of, for example, a metal having desirable conductivity. A circuit is formed on the conductor layer by using a known circuit processing method. Conductors forming the conductor layer include various metals having conductivity, such as gold, silver, copper, iron, nickel, aluminum, or alloy metals thereof. As a method for forming the conductor layer, a known method can be used. Examples include vapor deposition, electroless plating, and electrolytic plating. Alternatively, the metal foil (for example, copper foil) may be pressure-bonded by thermocompression bonding. The metal foil constituting the conductor layer is generally a metal foil used for electrical connection. In addition to the copper foil, various metal foils such as gold, silver, nickel, and aluminum can be used. It may also comprise an alloy foil substantially (for example, 98 wt % or more) composed of these metals. Among these metal foils, a copper foil is commonly used. The copper foil may be either a rolled copper foil or an electrolytic copper foil.

Advantageously, the composition of this invention fills the gap not hitherto attainable by the prior art materials. That is, as noted above, the compositions of this invention not only exhibit much needed low Dk/Df properties but also provides very high thermally stable materials as demonstrated by very high T_{g} and very high T_{d5} properties as discussed hereinabove.

Even more importantly the compositions of this invention can be formed into films/sheets of desirable thickness for forming various prepregs with glass cloth for fabricating into copper clad laminates. In some embodiments the film thickness of the films formed from the composition of this invention can be in the range of from about 75 to 150 microns, 90 to 120 microns suitable for forming metal clad laminates. In some embodiments the thickness can be lower than 75 microns or higher than 150 microns.

It should further be noted that various dielectric materials used in the applications mentioned herein must also withstand very harsh temperature conditions and must retain their dielectric properties for a long duration of time. Surprisingly, the films formed in accordance with this invention retain such low dielectric properties for a long period of time of up to 1000 hours or longer even when kept at high temperatures of about 125° C. or higher, thus providing additional benefit. The change of Dk or Df is very low, which can be as low as 3 percent or as low as one percent. Accordingly, in some embodiments of this invention the films formed in accordance with this invention retain substantially their Dk/Df properties for a period of 1000 hours or more at a temperature in the range of about 120° C. to 150° C. or higher.

As noted, the composition of this invention is generally used as such to form a film or sheet. In addition, the composition of this invention can also be used as a low molecular weight varnish-type material for certain applications. In such applications suitable amount of the desirable solvents can be added so as to maintain the solid content of the composition to about 10 to 70 weight percent when polymerized. Again, any of the solvents that are suitable to form such solutions can be used as a single solvent or a mixture of solvents as is needed for such application.

In a further aspect of this invention there is provided a kit for forming a film. There is dispensed in this kit a composition of this invention. Accordingly, in some embodiments there is provided a kit in which there is dispensed a polymer (or monomers of formulae (I) and (II) in desirable quantitate) as described herein, one or more crosslinking agents as described herein, a tackifier, a free radical generator as described herein; and one or more optional additives as described herein. In some embodiments the kit of this invention contains a polymer having two distinct monomers of formula (I) and a monomer of formula (II) in combination with at least one each of a crosslinking agent, tackifier, free radical generator and an optional additive so as to obtain a desirable result and/or for intended purpose. In some other embodiments the kit of this invention contains one or more monomers of formula (I) and optionally a monomer of formula (II) in combination with at least one each of a crosslinking agent, tackifier, free radical generator and an optional additive.

In another aspect of this embodiment of this invention the kit of this invention forms B-stageable film when subjected to suitable temperature for a sufficient length of time. That is to say that the composition of this invention is poured onto a surface or onto a substrate which needs to be encapsulated and exposed to suitable thermal treatment in order for the monomers to undergo polymerization to form a solid polymer which could be in the form of a film, or a sheet as described herein.

Generally, as already noted above, such polymerization can take place at various temperature conditions, such as for example heating, which can also be in stages, for example heating to 90° C., then at 110° C., and finally at 150° C. for sufficient length of time, for example 5 minutes to 2 hours at each temperature stage. The B-stages film can be further heated to higher than 150° C. for various lengths of time such as from 90 minutes to 180 minutes so as to cure the film to form a crosslinked polymeric network. By practice of this invention, it is now possible to obtain polymeric films on such substrates which are substantially uniform films. The thickness of the film can be as desired and as specifically noted above, and may generally be in the range of 50 to 500 microns or higher.

While making a sheet and to secure the flatness of the sheet and suppressing unintended shrinkage, various heating methods known to make sheet materials may be employed. For example, it is possible to heat at a relatively low temperature at first, and then gradually raise the temperature. In order to ensure flatness or the like, heating may be performed by pressurizing with a flat plate (metal plate) or the like before heating and/or by pressurizing with a flat plate. The pressure used for such pressurization may be, for example, 0.1 to 8 MPa, and in some other embodiments it may range from about 0.3 to 5 MPa.

In some embodiments, the kit as described herein encompasses various exemplary compositions as described hereinabove.

In yet another aspect of this invention there is further provided a method of forming a film for the fabrication of a variety of optoelectronic and/or automotive devices comprising:
forming a homogeneous clear composition comprising a polymer as described herein (or one or more monomers of formula (I) and optionally a monomer of formula (II)); one or more crosslinking agent as described herein; a tackifier as described herein; a free radical initiator as described herein; and optionally one or more additives, including a filler as described herein;
coating a suitable substrate with the composition or pouring the composition onto a suitable substrate to form a film; and
heating the film in stages to a suitable temperature to cause formation of the B-stageable film and a cured film.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. The mixture can also be poured onto a substrate to form a film. Suitable substrates include any appropriate substrate as is, or may be used for electrical, electronic, or optoelectronic devices, for example, a semiconductor substrate, a ceramic substrate, a glass substrate.

Next, the coated substrate is baked, i.e., heated to facilitate the removal of solvent and cross linking, for example to a temperature from 50° C. to 150° C. for about 1 to 180 minutes, although other appropriate temperatures and times can be used. That is, first forming the film by a B-stage process to remove any solvent present and then partially curing, and in a subsequent step at a higher temperature fully curing. In some embodiments the substrate is baked at a temperature of from about 100° C. to about 120° C. for 120 minutes to 180 minutes. In some other embodiments the substrate is baked at a temperature of from about 110° C. to about 140° C. for 60 minutes to 120 minutes. That is, these are the B-staged films. Finally, the B-staged films thus formed are further heated to temperatures higher than about 150° C. to fully cure the film.

The films thus formed are then evaluated for their electrical properties using any of the methods known in the art. For example, the dielectric constant (Dk) or permittivity and dielectric loss tangent at a frequency of 10 GHz was measured using a device for measuring the permittivity by the cavity resonator method (manufactured by AET, conforming to JIS C 2565 standard). The coefficient of thermal expansion (CTE) was measured using a thermomechanical analysis apparatus (made by Seiko Instruments, SS 6000) in accordance with a measurement sample size of about 4 mm (width)×40 mm (Length)×0.1 mm (thickness), a measurement temperature range of 30-350° C., and a temperature rising rate of 5° C./min. The coefficient of linear expansion from 50° C. to 100° C. was adopted as the coefficient of linear expansion. Generally, the films formed according to this invention exhibit excellent dielectric and thermal properties and can be tailored to desirable dielectric and thermal properties as described herein.

Accordingly, in some of the embodiments of this invention there is also provided a film or sheet obtained by the composition as described herein. In another embodiment there is also provided an electronic device comprising the film/sheet of this invention as described herein.

The composition of this invention can also be formed into a variety of composite structures which can be used as prepreg materials in the fabrication of metal clad laminates. Various types of metals can be used for this purpose, including for example copper, aluminum, stainless steel, among others. Metal clad lamination is well known in the art where layers of metal are cladded with insulation materials, such as for example the composition of this invention. For example, the compositions of this invention can be impregnated onto a glass fabric and then formed into a prepreg in a B-stage process by heating to suitable temperatures as described herein. Then the prepregs thus formed are sandwiched between layers of copper or other metal foil and cured at a temperature higher than 150° C. to form copper clad laminates.

It has now been found that the laminates thus formed in accordance with this invention exhibits excellent peel strength. That is, the cured films of this invention are so strongly bonded to either the glass surface or the metal surface it is difficult to peel the film from such substrates. Even more advantageously, it has now been surprisingly found that the peel strength can be increased by using optimum levels of the free radical initiator. For example, use of very low levels, i.e., less than 0.5 pphr of the free radical initiator can result in the composition exhibiting unacceptable peel strength. Whereas, use of free radical initiator in the range of about 2 to 3 pphr can provide surprisingly excellent peel strength. Accordingly, in some embodiments the peel strength of the composites formed in accordance with this invention can range from about 5 N/cm to about 8 N/cm or 9 N/cm or 11 N/cm or 13 N/cm or even higher depending upon the optimal amounts of free radical initiator used therein and the type of composite that is being made.

Accordingly, in some embodiments there is provided a glass cloth composite film/cloth (i.e., a prepreg) formed from the polymer of this invention, which exhibits a dielectric constant (Dk) less than 2.8 at a frequency of 10 GHz, a peel strength higher than 6 N/cm and a coefficient of thermal expansion (CTE) less than 40 ppm/K.

Advantageously, it has been further observed that the compositions of this invention can be coated uniformly onto a variety of glass or metal surfaces before curing such that any voids in the surface of such materials are fully covered. Then the coated surface is cured at a higher temperature to form a fully cured insulating layer, which is firmly bonded to such glass or metal surface. That is, for example, it is now possible to provide a metal foil with a coating of this composition to produce a printed wiring board or metal clad laminate in which the adhesion property between the insulating layer (i.e., the film formed from the composition of this invention), and the metal layer is excellent, and the loss at the time of signal transmission is further reduced.

Even more advantageously, it has now been found that the composition of this invention when applied onto a suitable surface can still flow and fill the voids before the two layers are well bonded. This is especially advantageous in the fabrication of metal clad laminates such as copper clad laminates where it is essential that all voids are completely insulated so as to further minimize loss at the time of signal transmission. Accordingly, in one aspect of this invention there is provided a method for producing a prepreg or a metal-clad laminate where a suitable glass fabric or a metal foil is coated with a composition of this invention and heated to suitable temperature in the range of from about 80° C. to 120° C. to form an uncured film of the composition of this invention on such glass fabric and/or metal foil. The composites thus formed are then cured at a higher temperature in the range of from about 160° C. to 200° C. to form fully cured laminates. It should particularly be noted that the polymers used in this aspect of the invention can be of very low molecular weight. That is, the weight average molecular weight (M_{w}) of the polymers employed in this aspect of the invention can be as low as 1,000 or can be in the range from about 1,000 to 5,000. The compositions of this invention exhibit excellent flow properties before they are fully cured and fill the surfaces uniformly on such glass fabric or metal foil, thus providing excellent insulating layer exhibiting very low dielectric constant and low loss properties as described herein.

The following examples are detailed descriptions of methods of preparation and use of certain compounds/monomers, polymers, and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### Examples (General)

The following abbreviations have been used hereinbefore and hereafter in describing some of the compounds, instruments and/or methods employed to illustrate certain of the embodiments of this invention:

NB—bicyclo[2.2.1]hept-2-ene; HexNB—5-hexylbicyclo[2.2.1]hept-2-ene; ButenylNB—5-(but-3-en-1-yl)bicyclo[2.2.1]hept-2-ene; CyHexeneNB—5-(cyclohex-3-en-1-yl)bicyclo[2.2.1]hept-2-ene; CyHexaneNB—5-cyclohexylbicyclo[2.2.1]hept-2-ene; Pd785—palladium (II) bis(tricyclohexylphosphine) diacetate; Pd1206—(acetonitrile)bis(triisopropylphosphine)-palladium(acetate) tetrakis(pentafluorophenyl)borate; Pd1602—bis(n-butyl-di-1-adamantylphosphine) palladium acetate(acetonitrile) tetrakis(pentafluorophenyl)borate; LiFABA—lithium tetrakis(pentafluorophenyl)borate diethyl etherate; DANFABA—dimethylanilinium tetrakis(pentafluorophenyl)borate; 1,4-CyHex-dimethacrylate—cyclohexane-1,4-diyl bis(2-methylacrylate); 1,4-CyHex(CH₂methacrylate)₂)—cyclohexane-1,4-diylbis(methylene) bis(2-methylacrylate; 1,3,5-CyHex-trimethacrylate—cyclohexane-1,3,5-triyl tris(2-methylacrylate); di-CyHex-dimethacrylate—[1,1′-bi(cyclohexane)]-4,4′-diyl bis(2-methylacrylate); NB-dimethacrylate—bicyclo[2.2.1]heptane-2,5-diyl bis(2-methylacrylate); NB—CP(CH₂-acrylate)₂-(octahydro-1H-4,7-methanoindene-1,5-diyl)bis(methylene) diacrylate; 1,4-CyHex(MI)₂—1,1′-(cyclohexane-1,4-diyl)bis(1H-pyrrole-2,5-dione); 1,4-CyHexCH₂-MI₂—1,1′-(cyclohexane-1,4-diylbis(methylene))bis(1H-pyrrole-2,5-dione); 2,5-NB(CH₂-DMMI)₂—1,1′-(bicyclo[2.2.1]heptane-2,5-diylbis(methylene))bis(3,4-dimethyl-1H-pyrrole-2,5-dione); TAIC—1,3,5-triallyl-1,3,5-triazinane-2,4,6-trione; DCP—dicumyl peroxide; B1000—1,2-butadiene rubber; T67—ethylene-propylene-ethylidenenorbornene terpolymer; Irganox-1076-3,5-bis(1,1-dirnethylethyl)-4-hydroxy-octadecyl ester benizenepropanoic acid; Irgafos-168—tris(2,4-ditert-butylphenyl)phosphite; BCO—bicyclo[4.2.0]oct-7-ene; TES—triethylsilane; TEA—triethyl amine; MCH—methylcyclohexane; EA—ethyl acetate; THF—tetrahydrofuran; DMF—dimethylformamide; DMAC—dimethyl acetamide; GPC—gel permeation chromatography; M_{w}—weight average molecular weight; Mₙ—number average molecular weight; PDI—polydispersity index; NMR—nuclear magnetic resonance spectroscopy; DSC—differential scanning calorimetry; TGA —thermogravimetric analysis; TMA—thermomechanical analysis; pphr—parts per hundred parts resin, i.e., the polymer according to this invention and as specifically described hereinbelow or parts per hundred parts of total monomers of formulae (I) and (II) as specifically described hereinbelow.

Various monomers as used herein are either commercially available or can be readily prepared following the procedures as described in U.S. Pat. No. 9,944,818.

### Example 1

### Terpolymer of NB/HexNB/CyHexeneNB (50/25/25)

A solution containing a mixture of NB (6.6 g, 70 mmol), HexNB (6.2 g, 35 mmol), CyHexeneNB (6.1 g, 35 mmol), BCO (0.122 g, 1.13 mmol) and LiFABA (0.018 g, 0.021 mmol in a 5 wt. % solution in anhydrous EA) dissolved in anhydrous toluene (43 g) was placed in a crimp-capped vial, sealed, and flushed with nitrogen. This solution was heated to 90° C. To this solution was added by syringe transfer a solution of Pd1602 (0.011 g, 0.007 mmol in a 1 wt. % solution in EA). The heating of the mixture at 90° C. while stirring was continued for 6 hours. The polymerized mixture was cooled to room temperature and poured to excess methanol (400 g) while stirring rapidly to precipitate the polymer. The liquids decanted and the solids dissolved in a solvent mixture of toluene (40 g) and THF (25 g). The solution was poured into methanol (400 mL) while stirring to precipitate the polymer. The liquids decanted and the solids washed with methanol (400 g) and dried in a vacuum oven at 80° C. for 24 hours to obtain the purified polymer (14.7 g, 78% isolated yield, GPC (THF): M_{w}=73,950, M_{w}=16,550, PDI=4.5). The molar composition of the title terpolymer (NB/HexNB/CyHexeneNB) was calculated to be 52/26/22 from ¹³C-NMR spectrum obtained in CDCl₃.

### Example 2

### Terpolymer of NB/HexNB/ButenylNB (35/40/25)

A solution containing a mixture of NB (4.3 g, 45.5 mmol), HexNB (9.3 g, 52 mmol), ButenylNB (4.8 g, 32.5 mmol), BCO (0.06 g, 0.56 mmol) and LiFABA (0.017 g, 0.02 mmol in a 5 wt. % solution in anhydrous EA) dissolved in anhydrous toluene (42 g) was placed in a crimp-capped vial, sealed, and flushed with nitrogen. This solution was heated to 90° C. To this solution was added by syringe transfer a solution of Pd1602 (0.010 g, 0.007 mmol in a 1 wt. % solution in EA). The heating of the mixture at 90° C. while stirring was continued for 6 hours. The polymerized mixture was cooled to room temperature and poured to excess methanol (400 g) while stirring rapidly to precipitate the polymer. The liquids decanted and the solids dissolved in a solvent mixture of toluene (40 g) and THF (25 g). The solution was poured into methanol (400 mL) while stirring to precipitate the polymer. The liquids decanted and the solids washed with methanol (400 g) and dried in a vacuum oven at 80° C. for 24 hours to obtain the purified polymer (16 g, 87% isolated yield, GPC (THF): M_{W}=25,900, M_{w}=6,725, PDI=3.9). The molar composition of the title terpolymer (NB/HexNB/CyHexeneNB) was calculated to be 40/40/20 from ¹³C-NMR spectrum obtained in CDCl₃.

### Example 3

### Terpolymer of NB/HexNB/CyHexeneNB (60/20/20)

A solution containing a mixture of NB (112.9 g, 1200 mmol, as 75 wt. % solution in toluene), HexNB (71.3 g, 400 mmol), CyHexeneNB (69.7 g, 400 mmol), BCO (1.08 g, 10 mmol) and LiFABA (0.26 g, 0.3 mmol) dissolved in anhydrous toluene (972 g) was placed in a glass reactor and flushed with nitrogen. This solution was heated to 80° C. in a nitrogen atmosphere. To this solution was added a solution of Pd1602 (0.16 g, 0.1 mmol in a 1.3 wt. % solution in anhydrous EA). The heating of the mixture at 80° C. while stirring was continued for 6 hours. Anhydrous THF (850 g) was added to the reaction mixture. The diluted polymerized mixture was cooled to room temperature and poured in three batches of about 525 g each to excess iso-propanol (about 2800 g each) while stirring rapidly to precipitate the polymer. The liquids filtered out and the solids were dried in a vacuum oven at 80-90° C. for 20-30 hours to obtain the purified polymer (164 g, 65% isolated yield). GPC (THF): M_{W}=140,600, M_{w}=44,850 PDI=3.1). The molar composition of the title terpolymer (NB/HexNB/CyHexeneNB) was calculated to be 62/20/17 from ¹³C-NMR spectrum obtained in CDCl₃.

### Example 3A

### Terpolymer of NB/HexNB/CyHexeneNB (60/20/20 molar ratio)

A mixture of NB (113 g, 1200 mmol, as 75 weight percent solution in toluene), HexNB (71.3 g, 400 mmol), CyHexeneNB (69.7 g, 400 mmol), BCO (1.08 g, 10 mmol) and LiFABA (0.26 g, 0.3 mmol) was dissolved in anhydrous toluene (545 g) taken in a glass reactor and flushed with nitrogen. This solution was heated to 80° C. in a nitrogen atmosphere. Pd1602 (0.16 g, 0.1 mmol, 1.3 wt. % solution in anhydrous EA) was added to the reaction mixture. The heating of the mixture at 80° C. while stirring was continued for 6 hours. THF (850 g) was then added to the reaction mixture. The diluted polymerized mixture was cooled to room temperature and poured in three batches of about 560 g each to excess methanol (about 2700 g each) while stirring rapidly to precipitate the polymer. The liquids were filtered out and the solids were dried in a vacuum oven at 80-90° C. for 20-30 hours to obtain the purified polymer (231 g, 91% isolated yield. GPC (THF): M_{w}=166,600, Mₙ=34,000, PDI=4.9. The monomeric composition of the terpolymer (NB/HexNB/CyHexeneNB) was calculated to be 64/19/17 from the ¹³C-NMR (CDCl₃) analysis.

### Example 4

### Tetrapolymer of NB/HexNB/CyHexeneNB/NB-methacrylate (60/20/10/10)

A solution containing a mixture of NB (8.5 g, 90 mmol), HexNB (5.3 g, 30 mmol), CyHexeneNB (6.1 g, 15 mmol), NB-methacrylate (2.7 g, 15 mmol), BCO (0.09 g, 0.8 mmol) and LiFABA (0.02 g, 0.023 mmol in a 5 wt. % solution in anhydrous EA) dissolved in anhydrous toluene (44 g) was placed in a crimp-capped vial sealed and flushed with nitrogen. This solution was heated to 90° C. To this solution was added by syringe transfer a solution of Pd1602 (0.012 g, 0.008 mmol in a 1 wt. % solution in EA). The heating of the mixture at 90° C. while stirring was continued for 6 hours. The polymerized mixture was cooled to room temperature and poured to excess methanol (400 g) while stirring rapidly to precipitate the polymer. The liquids decanted and the solids washed with excess methanol (400 mL) while stirring. The solid polymer was dried in a vacuum oven at 80° C. for 24 hours to obtain the purified polymer (10 g, 52% isolated yield, GPC (THF): M_{w}=104,500, M_{w}=37,900, PDI=2.8). Both ¹H-NMR and ¹³C-NMR spectra obtained in CDCl₃ showed peaks representing cyclohexene and methacrylate groups.

### Example 5

### Terpolymer of NB/HexNB/CyHexaneNB/NB-methacrylate (60/20/10/10)

A solution containing a mixture of NB (2.3 g, 24 mmol), HexNB (1.4 g, 8 mmol), CyHexaneNB (0.7 g, 4 mmol), NB-methacrylate (0.7 g, 4 mmol), BCO (0.035 g, 0.32 mmol) and DANFABA (0.005 g, 0.006 mmol in a 5 wt. % solution in anhydrous EA) dissolved in anhydrous toluene (12 g) was placed in a crimp-capped vial, sealed and flushed with nitrogen. This solution was heated to 90° C. To this solution was added by syringe transfer a solution of Pd1206 (0.002 g, 0.002 mmol in a 1 wt. % solution in EA). The heating of the mixture at 90° C. while stirring was continued for 6 hours. The polymerized mixture was cooled to room temperature and poured to excess methanol (200 g) while stirring rapidly to precipitate the polymer. The solid polymer dried in a vacuum oven at 80° C. for 24 hours to obtain the purified polymer (4.6 g, 90% isolated yield). GPC (THF): M_{W}=102,000, M_{w}=18,800, PDI=5.4). ¹H-NMR spectrum obtained in CDCl₃ showed peaks representing methacrylate group.

### Example 6

### 1,4-CyHex-dimethacrylate

Into a three-neck round bottom flask fitted with a thermometer, addition funnel and nitrogen inlet/outlet was placed a solution of cyclohexane-1,4-diol (10 g, 85 mmol) and TEA (20.8 g, 205 mmol) dissolved in anhydrous THF (150 g). This solution was cooled to 0° C. while stirring. Methacryloyl chloride (21.4 g, 205 mmol) was dissolved in anhydrous THF (50 g) and transferred to the addition funnel. This solution was slowly added to the cyclohexane-1,4-diol/TEA/THF solution at 0° C. dropwise (about 1 hour addition time). The reaction mixture was allowed to warm to ambient temperature and the stirring continued for 24 hours. Toluene (100 g) and hexanes (100 g) added and filtered to remove the precipitated triethyl amine hydrochloride. The liquid portion was washed with 20 wt. % sulfuric acid solution (150 g) three times followed by water (150 g) washes four times. The product was dried over anhydrous magnesium sulfate, filtered and rotary evaporated at 40-60° C. to remove the solvents to obtain a semi-solid (13 g, 50% isolated yield). Two peaks of about equal intensity were observed in gas chromatography. ¹H-NMR obtained in deuterated chloroform was consistent with the 1,4-CyHex-dimethacrylate structure.

### Example 7

### 1,4-CyHex(CH₂methacrylate)₂

Into a three-neck round bottom flask fitted with a thermometer, addition funnel and nitrogen inlet/outlet was placed a solution of cyclohexane-1,4-dimethanol (20 g, 140 mmol) and TEA (34.4 g, 340 mmol) dissolved in anhydrous THF (150 g). This solution was cooled to 0° C. while stirring. Methacryloyl chloride (35.1 g, 340 mmol) was dissolved in anhydrous THF (50 g) and transferred to the addition funnel. This solution was slowly added to the cyclohexane-1,4-dimethanol/TEA/THF solution at 0° C. dropwise (about 1 hour addition time). The reaction mixture was allowed to warm to ambient temperature and the stirring continued for 24 hours. Hexanes (100 g) added and filtered to remove the precipitated triethyl amine hydrochloride. The liquid portion was washed with 20 wt. % sulfuric acid solution (100 g) three times followed by water (150 g) washes six times. The product was dried over anhydrous magnesium sulfate, filtered and rotary evaporated at 50-60° C. to remove the solvents to obtain a solid product (21 g, 49% isolated yield). Potential molecular ion (m/z=281) was detected by GC-MS. ¹H-NMR obtained in deuterated chloroform was consistent with the CyHex(CH₂methacrylate)₂ structure.

### Example 8

### 1,3,5-CyHex-trimethacrylate

Into a three-neck round bottom flask fitted with a thermometer, addition funnel and nitrogen inlet/outlet was placed a solution of cyclohexane-1,3,5-triol (7 g, 53 mmol) and TEA (19.2 g, 190 mmol) were dissolved in methylene chloride (100 mL). This solution was cooled to 0° C. while stirring. Methacryloyl chloride (19.9 g, 190 mmol) was dissolved in methylene chloride (50 g) and transferred to the addition funnel. This solution was slowly added to the cyclohexane-1,3,5-triol/TEA/methylene chloride solution at 0° C. dropwise. The reaction mixture was allowed to warm to ambient temperature and the stirring continued for 20 hours. The reaction mixture was filtered to remove the precipitated triethyl amine hydrochloride. The liquid portion was washed with 20 wt. % sulfuric acid solution (200 g) followed by water (200 mL) washes four times. THF (about 25 g) added at each water wash to facilitate the phase separation. The product was dried over anhydrous magnesium sulfate, filtered and rotary evaporated at 40-60° C. to remove the solvents to obtain the crude product (9.2 g, 52% isolated yield). The crude product dissolved in THF (50 g) and filtered through a pad of silica gel followed by rotary evaporation to remove THF to obtain a liquid product (6.1 g, 34% isolated yield). ¹H-NMR obtained in deuterated chloroform was consistent with the presence of about 71% of 1,3,5-CyHex-trimethacrylate structure and about 29% CyHex(OH)dimethacrylate structure.

### Example 9

### di-CyHex-dimethacrylate

Into a three-neck round bottom flask fitted with a thermometer, addition funnel and nitrogen inlet/outlet was placed a solution of [1,1′-bi(cyclohexane)]-4,4′-diol (20 g, 100 mmol) and TEA (24.3 g, 240 mmol) dissolved in methylene chloride (200 g). This solution was cooled to 0° C. while stirring. Methacryloyl chloride (25 g, 240 mmol) was dissolved in methylene chloride (100 g) and transferred to the addition funnel. This solution was slowly added to the aforementioned solution at 0° C. dropwise. The reaction mixture was allowed to warm to ambient temperature and the stirring continued for 24 hours. A mixture of THF (100 g) and hexanes (100 g) was added, and the reaction mixture was filtered to remove the precipitated triethyl amine hydrochloride. The liquid portion was washed with 20 wt. % sulfuric acid solution (100 g) two times followed by water (150 mL) washes five times. THF (about 25 g) added at each water wash to facilitate the phase separation. The product was dried over anhydrous magnesium sulfate, filtered and rotary evaporated at 40-60° C. to remove the solvents to obtain the crude semi-solid product (23 g, 68% isolated yield). ¹H-NMR obtained in deuterated chloroform was consistent with the di-CyHex-dimethacrylate structure.

### Example 10

### NB-dimethacrylate

Into a three neck flask equipped with a nitrogen outlet, a mechanical stirrer and an addition funnel was placed a solution of 2,5-norbornenediol (2 g, 15.4 mmol) and TEA (8 ml) dissolved in THF (50 ml). The solution was then cooled to 0° C. To this was added methacryloyl chloride (4 ml, 41 mmol, dissolved in 8 ml of DCM) was added dropwise to the 2,5-norbornenediol solution over a 1 h period. During the addition, a white precipitate started to form. After the reaction mixture was stirred overnight, the white precipitate was filtered off, washed with (2×20 ml) DCM and filtrate was concentrated in vacuo. The residue was dissolved in 50 ml of toluene. The toluene solution was washed with 2 M HCl (3×25 ml), water (3×25 ml), 2 M NaOH (3×25 ml), water (3×25 ml), brine (25 ml), and dried with MgSO₄. The solvent was removed in vacuo and 1.5 g (36% yield) of a clear oil was obtained. Potential molecular ions (m/z=264) were detected by GC-MS. ¹H NMR spectrum was consistent with the expected product.

### Example 11

### 1,4-CyHex(MI)₂

Into a round bottom flask was placed a solution of 1,4-diaminocyclohexane dissolved in a 1:1 solvent mixture of toluene (25 ml) and DMF (25 ml). This solution was heated to 60° C. and then maleic anhydride (5.2 g, 53.2 mmol) was added. The heating at 60° C. was continued for 2 h after which polyphosphoric acid (79 g) was added to the reaction mixture. The reaction temperature was raised to 90° C. and the mixture was heated for an additional period of 12 h. At which time the reaction mixture was cooled to room temperature and poured into water. The resulting precipitate was collected. The precipitate was purified using column chromatography, gradient 50% ethyl acetate in heptane to 100% EA to obtain the title compound (0.5 g, 7% yield) as a white material. Potential molecular ion (m/z=274) was detected by GC-MS. ¹H and ¹³C NMR spectra were consistent with the expected product.

### Example 12

### 1,4-Bis(maleimidemethyl)cyclohexane (1,4-CyHexCH₂-MI₂)

Into a round bottom flask was placed a solution of 1,4-diaminomethylcyclohexane (5.08 g, 35.8 mmol) and maleic anhydride (6.93 g, 70.7 mmol) dissolved in DMAC (30 ml). The solution was heated to 50° C. for 1 h then concentrated. To this concentrate was added acetic anhydride (30 ml) and sodium acetate (5.83 g, 71.7 mmol). The mixture was then heated to reflux for 3 h. The reaction mixture was cooled to room temperature and then poured into 200 ml of water. The aqueous mixture was extracted with EA (3×60 ml). The combined organic layers were washed with water (2×60 ml) and brine (60 ml), dried with MgSO₄, and then concentrated in vacuo. The material was purified by column chromatography using EA as eluent to obtain the title compound as a white material (0.7 g, 6% yield). Potential molecular ion (m/z=302) was detected by GC-MS. ¹H and ¹³C NMR spectra were consistent with the expected product.

### Example 12A

### 1,1′-(Bicyclo[2.2.1]heptane-2,5-diylbis(methylene))bis(3,4-dimethyl-1H-pyrrole-2,5-dione) (2,5-NB(CH₂-DMMI)₂)

Dimethylmaleic anhydride (DMMA) (8.18 g, 64.8 mmol) was suspended in toluene inside a 250 ml reactor equipped with a thermowell, addition funnel, and Dean Stark trap. The mixture was heated to reflux. During heating all the DMMA dissolved. A solution of bis(2,5-aminomethyl)norbornane (5 g, 32.4 mmol) in 10 ml toluene was added dropwise over 1.5 hour. Noticeable frothing occurred during the first half of the addition and solids formed. During the second half of the addition, frothing lessened and a clear solution formed. The reaction solution was refluxed an additional 4 h. Water (0.75 ml) was collected in the Dean Stark trap. After allowing the mixture to cool overnight, GC analysis showed the reaction was complete. The mixture was concentrated and dried under hi-vacuum overnight to obtain the title compound.

### Example 13

### Reliability Studies at 125° C. Storage Conditions

This Example 13 illustrates the superiority of the polymer formed from an acrylate pendant norbornene monomers of formula (II) in accordance with the practice of this invention which properties are compared with a variety of other olefinic and/or other reactive monomers known in the art when used under similar conditions.

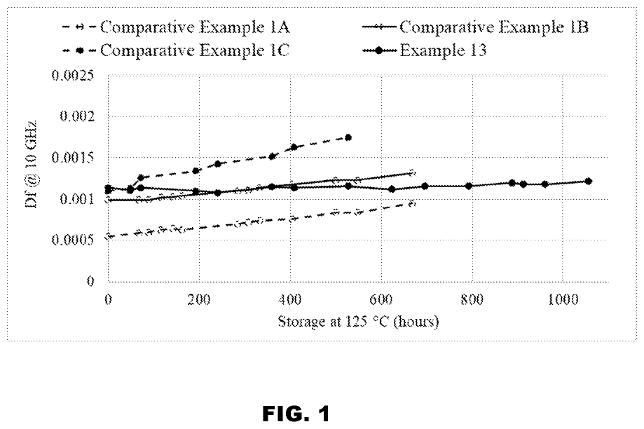

To a monomeric mixture of HexNB (1.6 g, 9 mmol) and NB-methacrylate (0.18 g, 1 mmol) was added Irganox-1076 (0.5 pphr of the monomers), Irgafos-168 (0.125 pphr of the monomers), Pd-785/MCH (0.08 g) and DANFABA/EA (0.08 g). The molar ratios of the monomers:Pd-785:DANFABA was about 10000:1:5. The monomers, catalyst and antioxidant mixture was doctor bladed onto a glass substrate and cured at 120° C. for 3 hours under a nitrogen atmosphere followed by 160° C. for 1 hour under vacuum in an oven. Under these conditions the monomer mixture was mass polymerized to form a film having a thickness of about 100 μm. Dielectric constant (Dk) and Dielectric dissipation factor (Df) were measured at 10 GHz, and the film was stored at 125° C. in air inside an oven. The Dk and Df of the film was periodically measured for 1056 hours to evaluate its reliability under high temperature storage since that is required for devices such as mm-Wave Antenna for automotive applications. The dielectric constant (Dk) of the composition of Example 13 changed only slightly from 2.17 to 2.12 (2.3% decrease) in 1056 hours indicating excellent reliability of Dk of this film that contained a reactive methacrylate group. Df also remained stable as shown in FIG. 1 unlike when reactive groups such as olefins or epoxy groups are present. Poor reliability of Df under high temperature storage was observed for all of the films formed from the compositions of Comparative Examples 1A-C. The Comparative Example 1A contained CyHexeneNB as the reactive olefinic monomer, Comparative Example 1B contained ButenylNB as the reactive olefinic monomer and Comparative Example 1C contained CHEpNB as the reactive monomer. It is evident from the data presented in FIG. 1 excellent reliability of Df of the composition from Example 13 was observed whereas all of the compositions from the Comparative Examples 1A-C showed poor reliability performance under identical conditions, thus demonstrating the superiority of the compositions formed in accordance with an embodiment of this invention.

### Examples 14A-14D

### Mass Polymerization of NB-Methacrylate Containing Compositions

Separately, one weight percent solution of Pd785 in MCH and a five weight percent solution of DANFABA in EA were prepared in crimp-cap vials and sealed. These stock solutions were used in Examples 14A-D. Four separate compositions were prepared as follows: a mixture of HexNB (1.42 g, 8 mmol) and NB-methacrylate (0.36 g, 2 mmol) was used in Example 14A (HexNB/NB-methacrylate, 80/20 mole ratio); a mixture of HexNB (1.42 g, 8 mmol), ButenylNB (0.15 g, 1 mmol) and NB-methacrylate (0.18 g, 1 mmol) was used in Example 14B (HexNB/ButenylNB/NB-methacrylate (80/10/10 mole ratio), a mixture of HexNB (1.07 g, 6 mmol), CyHexeneNB (0.52 g, 3 mmol) and NB-methacrylate (0.18 g, 1 mmol) was used in Example 14C (HexNB/CyHexeneNB/NB-methacrylate, 60/30/10) and a mixture of HexNB (1.07 g, 6 mmol), CyHexaneNB (0.53 g, 3 mmol) and NB-methacrylate (0.18 g, 1 mmol) was used in Example 14D (HexNB/CyHexaneNB/NB-methacrylate, 60/30/10). To each of these compositions were added Pd785/MCH (0.08 g), DANFABA/EA (0.08 g) and di-tert-butyl peroxide (about 4 pphr of the monomers as a thermal free radical initiator). The molar ratio of the monomers:Pd785:DANFABA was about 10,000:1:5 in each of the compositions. Each of the compositions were then doctor bladed on glass substrates and cured at 120° C. for 3 hours under a nitrogen atmosphere followed by 160° C. for 3 hours under nitrogen in an oven. Under these conditions each of the compositions mass polymerized to form films having thickness of about 100-150 μm. Dielectric constant at 10 GHz (Dk), Dielectric dissipation factor at 10 GHz (Df), glass transition temperatures (T_{g}), coefficients of thermal expansion (CTE) and the temperature at which film lost its five percent of the weight (T_{d5}) were measured for each of the films formed. The results are summarized in Table 1. It is evident from the data presented in Table 1 low Dk and Df were observed for all of the films thus demonstrating their suitability in a variety of low loss applications as described herein. It should further be noted that the CTEs were also low that could be further reduced by incorporating inorganic fillers suitable for low loss applications. It is further demonstrated that the compositions of Examples 14A-14D exhibit high glass transition temperatures (T_{g}) and high decomposition temperatures (T_{d5}) that are required for thermal stability of a variety of low loss devices.

TABLE 1

| Example No. | Dk | Df | CTE (ppm/K) | T_{g} (° C.) | T_{d5} (° C.) |
|---|---|---|---|---|---|
| Example 14A | 2.23 | 0.0011 | 163 | 246 | 368 |
| Example 14B | 2.19 | 0.0013 | 166 | 241 | 279 |
| Example 14C | 2.36 | 0.0005 | 125 | 305 | 370 |
| Example 14D | 2.18 | 0.0008 | 141 | 300 | 381 |

### Example 15

### Mass Polymerization of HexNB/CyclohexeneNB with Acrylate Crosslinkers

To a monomer mixture of HexNB/CyHexeneNB (1.8 g, 70/30 mole ratio) was added one weight percent solution of Pd785 in MCH (0.08 g), a five percent solution of DANFABA in EA (0.08 g) and di-tert-butyl peroxide (about 4 pphr of the monomers as a thermal free radical initiator). The molar ratio of the monomers:Pd785:DANFABA was about 10,000:1:5. NB—CP(CH₂-acrylate)₂ was also added (10 pphr of the monomers). The composition was doctor bladed on glass substrates and cured at 120° C. for 3 hours under a nitrogen atmosphere followed by 160° C. for 3 hours under nitrogen in an oven. The composition was mass polymerized to form a film having a thickness of about 100 μm. The film exhibited a low dielectric constant (Dk) of 2.15 at 10 GHz and low dielectric dissipation factor (Df) of 0.00197 at 10 GHz.

### Examples 16A-16C

### Mass Polymerization of HexNB/CyclohexeneNB with Various Acrylate Crosslinkers

To a monomer mixture of HexNB/CyHexeneNB (1.8 g, 70/30 mole ratio) was added one weight percent solution of Pd785 in MCH (0.08 g), a five percent solution of DANFABA in EA (0.08 g). This solution was split into three separate portions and for each portion different amounts of methacrylate cross linker 1,4-CyHex-dimethacrylate), di-tert-butyl peroxide (DTBP) or di-cumyl peroxide (DCP) were added as listed in Table 2 to form respectively three separate compositions, Example 16A, Example 16B and Example 16C. The molar ratio of the monomers:Pd785:DANFABA was about 10,000:1:5 in each of these compositions. Each of the compositions were then doctor bladed on glass substrates and cured at 120° C. for 3 hours under a nitrogen atmosphere followed by 160° C. for 2 hours under vacuum in an oven. The monomer mixtures were fully mass polymerized under these conditions to form films of about 100 μm thickness. Dielectric constant (Dk) and Dielectric dissipation factor (Df) at 10 GHz were measured for each of these films and are listed in Table 2. It is evident from the data presented in Table 2 that all of the compositions from Examples 16A-16C exhibited very low Dk and Df values. It is also observed that use of higher amounts of the crosslinker results in even lower Dk properties as seen in Example 16C while still maintaining similar low loss properties.

TABLE 2

| | 1,4-CyHex- | | | | |
|---|---|---|---|---|---|
| Example No. | dimethacrylate) | DTBP | DCP | Dk | Df |
| Example 16A | 10 pphr | 4 pphr | — | 2.36 | 0.0005 |
| Example 16B | 10 pphr | — | 4 pphr | 2.36 | 0.0007 |
| Example 16C | 20 pphr | — | 4 pphr | 2.21 | 0.0008 |

### Examples 17A-17B

### NB/HexNB/CyHexeneNB/NB-methacrylate Polymer Compositions

The polymer formed in Example 4 (NB/HexNB/CyHexeneNB/NB-methacrylate, 60/20/10/10 mole ratio) was dissolved in mesitylene to prepare 20 wt. % solution (Example 17A). To a portion of this solution was added di-cumyl peroxide (DCP, 2 pphr, Example 17B). These compositions were doctor bladed on glass substrates and heated to 130° C. for 1 hour to remove the solvent (B-staged). The solubility of small pieces of the B-staged films were measured in THF. These B-staged films were further cured at 180° C. for 1 hour under nitrogen atmosphere followed by 180° C. for 1 hour under vacuum in an oven to form films having thickness of about 100 μm. The solubility of small pieces of the fully cured films were measured in THF. Dielectric constant (Dk) and dielectric dissipation factor (Df) were measured at 10 GHz. Table 3 summarize the results. The B-staged films retained their solubility at least partially in THF for both examples. The fully cured film of Example 17A that did not have a thermal free radical initiator still retained the solubility in THF indicating no cross linking had happened. The fully cured film of Example 17B lost its solubility in THF indicating cross linking to form a thermoset in the presence of a thermal free radical initiator. The films had low Dk and Df. Therefore, the polymer composition of Example 17B was deemed suitable to be used in Cu clad laminates that require low loss high performance thermosets.

TABLE 3

| | | Cure | THF | | |
|---|---|---|---|---|---|
| Example No. | DCP | condition | solubility | Dk | Df |
| Example 17A | — | B-staged | Yes | — | — |
| Example 17A | — | Fully cured | Yes | 2.17 | 0.0010 |
| Example 17B | 2 pphr | B-staged | Partial | 2.29 | 0.0011 |
| Example 17B | 2 pphr | Fully cured | No | 2.12 | 0.0015 |

### Example 18

### NB/HexNB/CyHexaneNB/NB-methacrylate Polymer Composition

The polymer formed in Example 5 (NB/HexNB/CyHexaneNB/NB-methacrylate, 60/20/10/10 molar ratio) was dissolved in mesitylene to prepare 20 wt. % solution. To a portion of this solution was added B1000 (20 pphr), T67 (15 pphr), TAIC (10 pphr) and DCP (1 pphr). This composition was doctor bladed on a glass substrate and heated to 130° C. for 1 hour under nitrogen atmosphere to remove the solvent (B-staged). This B-staged film was further cured under two conditions at 180° C. for 1.5 hours under vacuum (Cure-1) or 200° C. for 1.5 hours under vacuum (Cure-2). THF solubility, dielectric constant (Dk) and dielectric dissipation factor (Df) at 10 GHz were measured and listed in Table 4. The results indicate that this composition is suitable to be used in Cu clad laminates that require low loss high performance thermoset.

TABLE 4

| Cure condition | THF solubility | Dk | Df |
|---|---|---|---|
| B-staged | Partial | 2.26 | 0.0014 |
| Cure-1 | No | 2.25 | 0.0012 |
| Cure-2 | No | 2.16 | 0.0010 |

### Examples 19A-19B

### NB/HexNB/CyHexeneNB Polymer Composition

The polymer formed in Example 1 (NB/HexNB/CyHexeneNB, 50/25/25 molar ratio) was dissolved in mesitylene to prepare 25 wt. % solution. To portions of this solution were added 1,4-CyHex-dimethacrylate) (15 pphr) and DCP (2 pphr). Additionally, B1000 (15 pphr) was added to Example 19B. These compositions were doctor bladed on glass substrates and heated to 130° C. for 1 hour under nitrogen atmosphere to remove the solvent (B-staged). These B-staged films were fully cured at 170° C. for 1 hour under nitrogen atmosphere and 170° C. for 2 hours under vacuum in an oven to generate films having thickness of about 100 μm. THF solubility, CTE, T_{g}, dielectric constant (Dk) and dielectric dissipation factor (Df) at 10 GHz were measured and listed in Table 5. The results indicate that these compositions are suitable to be used in Cu clad laminates that require low loss high performance thermoset.

### Example 20

### NB/HexNB/ButenylNB Polymer Composition

The polymer formed in Example 2 (NB/HexNB/ButenylNB, 35/40/25 molar ratio) was dissolved in mesitylene to prepare 35 wt. % solution. To a portion of this solution was added 1,4-CyHex-dimethacrylate) (15 pphr), B1000 (15 pphr) and DCP (2 pphr). This composition was doctor bladed on a glass substrate and heated to 130° C. for 1 hour under nitrogen atmosphere to remove the solvent (B-staged). This B-staged film was fully cured at 170° C. for 1 hour under nitrogen atmosphere and at 170° C. for 2 hours under vacuum in an oven to generate a film having thickness of about 100 μm. THF solubility, CTE, T_{g}, dielectric constant (Dk) and dielectric dissipation factor (Df) at 10 GHz were measured and listed in Table 5. The results indicate that these compositions are suitable to be used in Cu clad laminates that require low loss high performance thermoset.

TABLE 5

| | Cure | THF | | | CTE | T_{g} |
|---|---|---|---|---|---|---|
| Example No. | condition | solubility | Dk | Df | (ppm/k) | (° C.) |
| Example 19A | B-staged | Yes | — | — | — | — |
| Example 19A | Fully cured | No | 2.23 | 0.0020 | 109 | 296 |
| Example 19B | B-staged | Yes | — | — | — | — |
| Example 19B | Fully cured | No | 2.30 | 0.0013 | 115 | 274 |
| Example 20 | B-staged | Yes | — | — | — | — |
| Example 20 | Fully cured | No | 2.25 | 0.0014 | 113 | 218 |

### Example 21

### NB/HexNB/CyHexeneNB Polymer Composition

The polymer formed in Example 1 (NB/HexNB/CyHexeneNB, 50/25/25 molar ratio) was dissolved in mesitylene to prepare 25 wt. % solution. To a portion of this solution was added 1,4-CyHex-dimethacrylate) (20 pphr), B1000 (10 pphr) and DCP (2 pphr). This composition was doctor bladed on a glass substrate and heated to 120° C. for 30 minutes under nitrogen atmosphere to remove the solvent (B-staged). This B-staged film was fully cured at 180° C. for 1 hour under nitrogen atmosphere and 180° C. for 1 hour under vacuum in an oven to generate a film having thickness of about 100 μm. The film properties were measured: CTE (89 ppm/K), T_{g} (264° C.), dielectric constant (Dk) at 10 GHz (2.29) and dielectric dissipation factor (Df) at 10 GHz (0.0014). The results indicate that this composition is suitable to be used in Cu clad laminates that require low loss high performance thermoset.

### Examples 22A-22E

### NB/HexNB/CyHexeneNB/NB-methacrylate Polymer Compositions

The polymer formed in Example 4 (NB/HexNB/CyHexeneNB/NB-methacrylate, 60/20/10/10 molar ratio) was dissolved in mesitylene to prepare 20 wt. % solution. To portions of this solution were added B1000, T67, TAIC, 1,4-CyHex-dimethacrylate or 1,3,5-CyHex-trimethacrylate and DCP (2 pphr for all examples) as listed in Table 6. These compositions were doctor bladed on glass substrates and heated to 130° C. for 1 hour under nitrogen atmosphere to remove the solvent (B-staged). These B-staged films were fully cured at 180° C. for 1 hour under nitrogen atmosphere and 180° C. for 2 hours under vacuum in an oven to generate films having thickness of about 100-200 μm. THF solubility, CTE, T_{g}, dielectric constant (Dk) and dielectric dissipation factor (Df) at 10 GHz were measured for the fully cured films and the results are summarized in Table 7. The results indicate that these compositions are suitable to be used in Cu clad laminates that require low loss high performance thermosets.

TABLE 6

| | | | | | 1,3,5- |
|---|---|---|---|---|---|
| | | | | 1,4-CyHex- | CyHex- |
| | | | | dimeth- | trimeth- |
| Example No. | B1000 | T67 | TAIC | acrylate | acrylate |
| Example 22A | 20 pphr | 15 pphr | 10 pphr | — | — |
| Example 22B | 20 pphr | 15 pphr | — | 10 pphr | — |
| Example 22C | 20 pphr | 15 pphr | — | — | 10 pphr |
| Example 22D | 20 pphr | 15 pphr | — | 20 pphr | — |
| Example 22E | 20 pphr | 15 pphr | — | — | 20 pphr |

TABLE 7

| | THF | | | | |
|---|---|---|---|---|---|
| Example No. | solubility | Dk | Df | CTE (ppm/K) | T_{g} (° C.) |
| Example 22A | No | 2.26 | 0.0010 | 95 | 270 |
| Example 22B | No | 2.07 | 0.0012 | 84 | 225 |
| Example 22C | No | 2.05 | 0.0014 | 87 | 260 |
| Example 22D | No | 2.18 | 0.0015 | 88 | 218 |
| Example 22E | No | 2.13 | 0.0020 | 116 | 300 |

### Examples 23A-23B

### NB/HexNB/CyHexeneNB (60/20/20) Polymer Compositions

The polymer formed in Example 3 (NB/HexNB/CyHexeneNB, 60/20/20 molar ratio) was dissolved in mesitylene to prepare 20 wt. % solution. To portions of this solution were added B1000 (20 pphr), T67 (15 pphr) and NB-dimethacrylate (10 pphr) for Example 23A or di-CyHex-dimethacrylate (10 pphr) for Example 23B and DCP (2 pphr) for both. These compositions were doctor bladed on glass substrates and heated to 110° C. for 30 minutes followed by 130° C. for 1 hour under nitrogen atmosphere to remove the solvent (B-staged). These B-staged films were fully cured at 180° C. for 1 hour under nitrogen atmosphere and 200° C. for 2 hours under vacuum in an oven to generate films having thickness of about 100 μm. CTE, T_{g}, T_{d5}, dielectric constant (Dk) and dielectric dissipation factor (Df) at 10 GHz were measured for the fully cured films and the results are summarized in Table 8. The results indicate that these compositions are suitable to be used in Cu clad laminates that require low loss high performance thermoset.

TABLE 8

| Example No. | Dk | Df | CTE (ppm/K) | T_{g} (° C.) | T_{d5} (° C.) |
|---|---|---|---|---|---|
| Example 23A | 2.25 | 0.0013 | 89 | 332 | 376 |
| Example 23B | 2.86 | 0.0038 | 62 | 323 | 322 |

### Examples 24A-24B

### Maleimide as Crosslinkers

The polymer formed in Example 3A (NB/HexNB/CyHexeneNB, 60/20/20 molar ratio) was dissolved in decalin to prepare 15 wt. % solution. To portions of this solution were added 1,4-CyHex(MI)₂ (10 pphr) and DCP (1 pphr) for Example 24A and 2,5-NB(CH₂-DMMI)₂ (10 pphr) and DCP (0.5 pphr) for Example 24B. These compositions were doctor bladed on glass substrates and heated to 130° C. for 1 hour under nitrogen atmosphere to remove the solvent (B-staged). These B-staged films were fully cured at 190° C. for 2 hours under vacuum in an oven to generate films having thickness of about 75 μm (Example 24A) and 85 μm (Example 24B). CTE, T_{g}, T_{d5}, dielectric constant (Dk) and dielectric dissipation factor (Df) at 10 GHz were measured for the fully cured films and the results are summarized in Table 9. The results indicate that these compositions are suitable to be used in Cu clad laminates that require low loss high performance thermoset.

TABLE 9

| Example No. | Dk | Df | CTE (ppm/K) | T_{g} (° C.) | T_{d5} (° C.) |
|---|---|---|---|---|---|
| Example 24A | 2.22 | 0.0004 | 88 | 307 | 346 |
| Example 24B | 2.23 | 0.0004 | — | — | — |

### Example 25

### Maleimide as Crosslinker

The polymer formed in Example 3A (NB/HexNB/CyHexeneNB, 60/20/20 molar ratio) was dissolved in decalin to prepare 15 wt. % solution. To a portion of this solution was added 2,5-NB(CH₂-DMMI)₂ (10 pphr), T67 (15 pphr) and DCP (1 pphr). This composition was doctor bladed on a glass substrate and heated to 130° C. for 1 hour under nitrogen atmosphere to remove the solvent (B-staged). This B-staged film was fully cured at 190° C. for 1.5 hours under vacuum in an oven to generate a film having thickness of about 100 μm. The film exhibited the following properties: CTE=110 ppm/K, T_{g}=268° C., T_{d5}=357° C., dielectric constant (Dk=2.13) and dielectric dissipation factor (Df=0.0005) at 10 GHz. The results indicate that this composition is suitable to be used in Cu clad laminates that require low loss high performance thermoset.

### Examples 26A-26B

### Maleimides as Crosslinkers

The polymer formed in Example 4 (NB/HexNB/CyHexeneNB/NB-methacrylate, 60/20/10/10 molar ratio) was dissolved in mesitylene to prepare 20 wt. % solution. To portions of this solution were added 2,5-NB(CH₂-DMMI)₂ (10 pphr) and DCP (1 pphr) for Example 26A and 2,5-NB(CH₂-DMMI)₂ (10 pphr), T67 (15 pphr) and DCP (1 phr) for Example 26B. These compositions were doctor bladed on glass substrates and heated to 130° C. for 1 hour under nitrogen atmosphere to remove the solvent (B-staged). These B-staged films were fully cured at 190° C. for 1.5 hours under vacuum in an oven to generate films having thickness of about 100-150 μm. CTE, T_{g}, dielectric constant (Dk) and dielectric dissipation factor (Df) at 10 GHz were measured for the fully cured films and the results are summarized in Table 10. The results indicate that these compositions are suitable to be used in Cu clad laminates that require low loss high performance thermosets.

TABLE 10

| Example No. | Dk | Df | CTE (ppm/K) | T_{g} (° C.) | T_{d5} (° C.) |
|---|---|---|---|---|---|
| Example 26A | 2.28 | 0.0015 | — | — | — |
| Example 26B | 2.23 | 0.0014 | 93 | 228 | 326 |

### Example 27

### Film Fusing Studies

The B-staged films in Examples 22B, 22D and 22E were fused by placing two films on top of each other and pressing at 10 MPa pressure at 160° C. for 1.5 hours. The films were fused together indicating the suitability of these compositions for Cu clad laminates that require the fabrication of complex layered structures. Table 11 summarizes the results of film fusing examples. The film thicknesses of the fused films were approximately double the size of individual films or slightly lower indicating that some films may have flowed during the pressing at 10 MPa and at 160° C.

TABLE 11

| | Film Thickness | Film Thickness |
|---|---|---|
| Example No. | before fusing | after fusing |
| Example 22B | 2 × 160 μm | 320 μm |
| Example 22D | 2 × 170 μm | 340 μm |
| Example 22E | 2 × 190 μm | 360 μm |

### Comparative Examples 1A-1C

### Reliability Studies at 125° C. Storage

A mixture of HexNB (1.34 g, 7.53 mmol) and CyHexeneNB (0.44 g, 2.53 mmol) was used in Comparative Example 1A; a mixture of HexNB (1.34 g, 7.98 mmol) and ButenylNB (0.37 g, 2.50 mmol) was used in Comparative Example 1B; and a mixture of HexNB (1.42 g, 7.98 mmol) and CHEpNB (0.38 g, 2.00 mmol) was used in Comparative Example 1C. To each of these mixtures were added Irganox-1076 (0.5 pphr of the monomers), Irgafos-168 (0.125 pphr of the monomers), Pd785/MCH (0.08 g) and DANFABA/EA (0.08 g) as prepared in Example 13. The molar ratios of the monomers:Pd785:DANFABA was about 10,000:1:5 in each of the mixtures. These compositions were doctor bladed on glass substrates and cured at 120° C. for 3 hours under a nitrogen atmosphere in an oven followed by 160° C. for 1 hour under vacuum in an oven. The monomer mixtures mass polymerized to form films having thickness of about 100-150 μm. Dielectric constant (Dk) and Dielectric dissipation factor (Df) of each of the film formed was measured, and the films were stored at 125° C. in air inside an oven. The Dk and Df of the films were periodically measured for 500-700 hours to evaluate their reliability under high temperature storage since that is required for devices such as mm-Wave Antenna for automotive applications. FIG. 1 shows the reliability of Df during the high temperature storage of these compositions that contain reactive groups such as olefins or epoxy. The reliabilities were not good and the dielectric dissipation factors significantly increased during storage compared to the reliability shown in Example 13.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A polymer comprising:
a) at least one first repeating unit represented by formula (IA), said first repeating unit is derived from a monomer of formula (I): 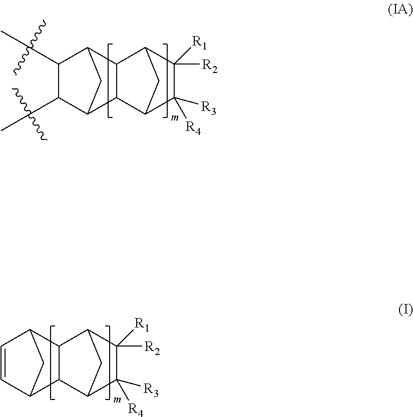
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl, (C₆-C₁₂)aryl(C₁-C₆)alkyl, methylidene, ethylidene, vinyl, linear or branched (C₃-C₁₆)alkenyl, (C₃-C₁₀)cycloalkenyl, (C₆-C₁₂)bicycloalkenyl, (C₆-C₁₂)aryl(C₂-C₁₆)alkenyl, epoxy(C₁-C₆)alkyl and epoxy(C₃-C₈)cycloalkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II): 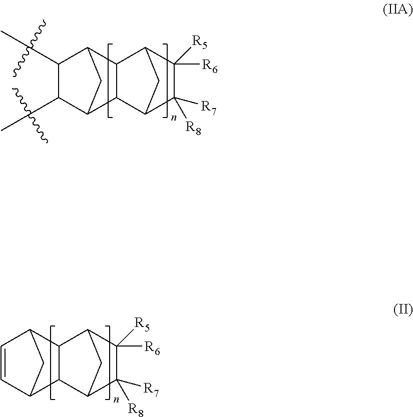
wherein: [symbol]
denotes a place of bonding with another repeat unit;
n is an integer 0, 1 or 2;
at least one of R₅, R₆, R₇ and R₈ is selected from the group consisting of acrylate, methacrylate, (C₁-C₆)alkylacrylate and (C₁-C₆)alkylmethacrylate, and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the second repeat unit is present at an amount not less than four mole percent based on total moles of first and second repeat units.

2. The polymer according to claim 1, wherein the monomer of formula (I) is selected from the group consisting of: 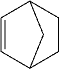
bicyclo[2.2.1]hept-2-ene (norbornene or NB); 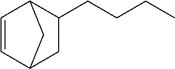
5-butylbicyclo[2.2.1]hept-2-ene (BuNB); 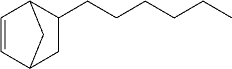
5-hexylbicyclo[2.2.1]hept-2-ene (HexNB); 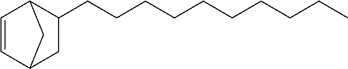 [SMILES: CCCCCCCCCCC1CC2C=CC1C2]
5-decylbicyclo[2.2.1]hept-2-ene (DecNB); 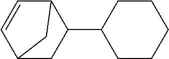 [SMILES: C1=CC2CC1CC2C1CCCCC1]
5-cyclohexylbicyclo[2.2.1]hept-2-ene (CyHexaneNB); 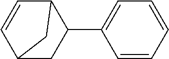 [SMILES: C1=CC2CC1CC2c1ccccc1]
5-phenylbicyclo[2.2.1]hept-2-ene (PhNB); 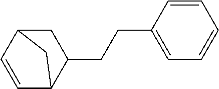 [SMILES: C1=CC2CC1CC2CCc1ccccc1]
5-phenethylbicyclo[2.2.1]hept-2-ene (PENB); 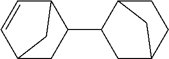 [SMILES: C1=CC2CC1CC2C1CC2CCC1C2]
2,2′-bi(bicyclo[2.2.1]heptan-5-ene) (NBANB); 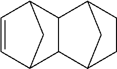 [SMILES: C1=CC2CC1C1C3CCC(C3)C21]
1,2,3,4,4a,5,8,8a-octahydro-1,4:5,8-dimethanonaphthalene (TD); 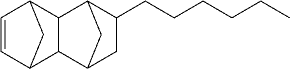 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD); 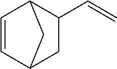
5-vinylbicyclo[2.2.1]hept-2-ene (VNB); 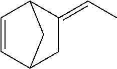
5-ethylidenebicyclo[2.2.1]hept-2-ene (ENB); 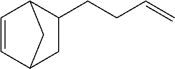
5-(but-3-en-1-yl)bicyclo[2.2.1]hept-2-ene (ButenylNB); 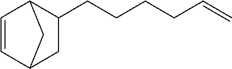
5-(hex-5-en-1-yl)bicyclo[2.2.1]hept-2-ene (HexenylNB); 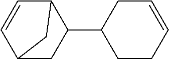 [SMILES: C1=CCC(C2CC3C=CC2C3)CC1]
5-(cyclohex-3-en-1-yl)bicyclo[2.2.1]hept-2-ene (CyHexeneNB); 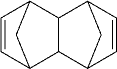 [SMILES: C1=CC2CC1C1C3C=CC(C3)C21]
1,4,4a,5,8,8a-hexahydro-1,4:5,8-dimethanonaphthalene (TDD); 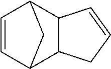
3a,4,7,7a-tetrahydro-1H-4,7-methanoindene (DCPD); 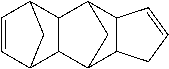 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3);
and 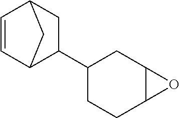 [SMILES: C1=CC2CC1CC2C1CCC2OC2C1]
3-(bicyclo[2.2.1]hept-5-en-2-yl)-7-oxabicyclo[4.1.0]heptane (CHEpNB).

3. The polymer according to claim 1, wherein the monomer of formula (II) is selected from the group consisting of: 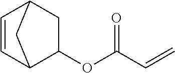
bicyclo[2.2.1]hept-5-en-2-yl acrylate (NB-acrylate); 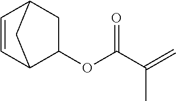
bicyclo[2.2.1]hept-5-en-2-yl methacrylate (NB-methacrylate); 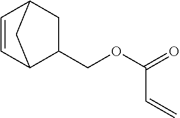
bicyclo[2.2.1]hept-5-en-2-ylmethyl acrylate (NBCH2-acrylate); and 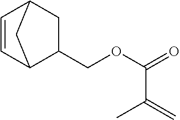
bicyclo[2.2.1]hept-5-en-2-ylmethyl methacrylate (NBCH2-methacrylate).

4. The polymer according to claim 1, which is selected from the group consisting of:
a tetrapolymer of norbornene (NB), 5-hexylbicyclo[2.2.1]hept-2-ene (HexNB),
5-cyclohexylbicyclo[2.2.1]hept-2-ene (CyHexaneNB) and bicyclo[2.2.1]hept-5-en-2-yl methacrylate (NB-methacrylate); and
a tetrapolymer of norbornene (NB), 5-hexylbicyclo[2.2.1]hept-2-ene (HexNB),
5-(cyclohex-3-en-1-yl)bicyclo[2.2.1]hept-2-ene (CyHexeneNB) and bicyclo[2.2.1]hept-5-en-2-yl methacrylate (NB-methacrylate).

5. A composition comprising:
a) a polymer comprising:
i) at least one first repeating unit represented by formula (IA), said first repeating unit is derived from a monomer of formula (I): 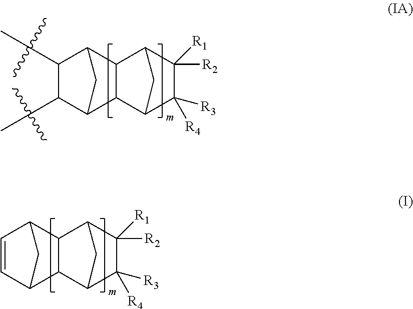
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl, (C₆-C₁₂)aryl(C₁-C₆)alkyl, methylidene, ethylidene, vinyl, linear or branched (C₃-C₁₆)alkenyl, (C₃-C₁₀)cycloalkenyl, (C₆-C₁₂)bicycloalkenyl, (C₆-C₁₂)aryl(C₂-C₁₆)alkenyl, epoxy(C₁-C₆)alkyl and epoxy(C₃-C₅)cycloalkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) a second repeating unit represented by formula (IIA), said second repeating unit is derived from a monomer of formula (II): 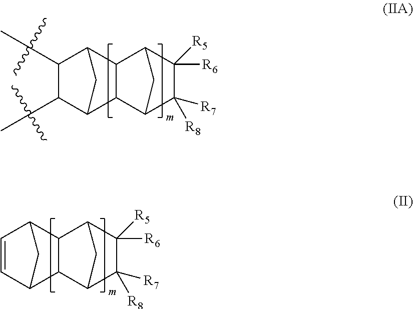
wherein: [symbol]
denotes a place of bonding with another repeat unit;
n is an integer 0, 1 or 2;
at least one of R₅, R₆, R₇ and R₈ is selected from the group consisting of acrylate, methacrylate, (C₁-C₆)alkylacrylate and (C₁-C₆)alkylmethacrylate, and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount from about zero mole percent to about twenty mole percent based on total moles of first and second repeat units;
b) a crosslinking agent selected from the group consisting of: 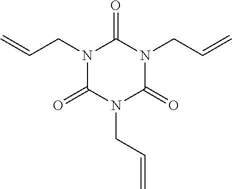 [SMILES: C=CCn1c(=O)n(CC=C)c(=O)n(CC=C)c1=O]
1,3,5-triallyl-1,3,5-triazinane-2,4,6-trione (TAIC); 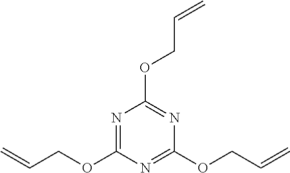 [SMILES: C=CCOc1nc(OCC=C)nc(OCC=C)n1]
2,4,6-tris(allyloxy)-1,3,5-triazine (TAC);
a compound of formula (III):
X-(A)ₚ (III)
wherein,
p is an integer from 2 to 6;
A is acrylate or methacylate;
X is selected from the group consisting of substituted or unsubstituted (C₁-C₁₆)alkyl,
(C₃-C₁₆)cycloalkyl, (C₃-C₁₆)cycloalkyl(C₁-C₆)alkyl, (C₆-C₁₆)bicycloalkyl,
(C₆-C₁₆)bicycloalkyl(C₁-C₆)alkyl, (C₈-C₁₆)tricycloalkyl and
(C₈-C₁₆)tricycloalkyl(C₁-C₆)alkyl;
a compound of formula (IV):
Y—(B)_{q} (IV)
wherein,
q is an integer from 2 to 6;
B is a radical of formula (V): 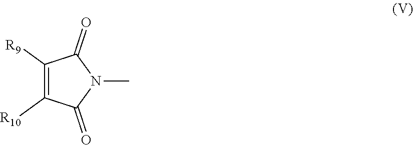
wherein R₉ and R₁₀ are the same or different and each independently selected from the group consisting of hydrogen, methyl, ethyl and linear or branched (C₃-C₆)alkyl;
Y is selected from the group consisting of substituted or unsubstituted (C₃-C₁₆)cycloalkyl, (C₃-C₁₆)cycloalkyl(C₁-C₆)alkyl, (C₆-C₁₆)bicycloalkyl,
(C₆-C₁₆)bicycloalkyl(C₁-C₆)alkyl, (C₈-C₁₆)tricycloalkyl and
(C₈-C₁₆)tricycloalkyl(C₁-C₆)alkyl; and
a mixture in any combination thereof; and
c) one or more additives selected from the group consisting of a tackifier and a free radical initiator.

6. The composition according to claim 5, wherein the first repeat unit of the polymer is derived from the monomer of formula (I) selected from the group consisting of: 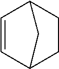
bicyclo[2.2.1]hept-2-ene norbornene or NB); 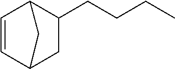
5-butylbicyclo[2.2.1]hept-2-ene (BuNB); 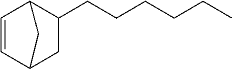
5-hexylbicyclo[2.2.1]hept-2-ene (HexNB); 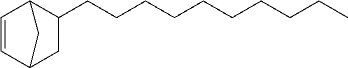 [SMILES: CCCCCCCCCCC1CC2C=CC1C2]
5-decylbicyclo[2.2.1]hept-2-ene (DecNB); 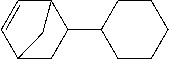 [SMILES: C1=CC2CC1CC2C1CCCCC1]
5-cyclohexylbicyclo[2.2.1]hept-2-ene (CyHexaneNB); 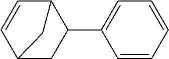 [SMILES: C1=CC2CC1CC2c1ccccc1]
5-phenylbicyclo[2.2.1]hept-2-ene (PhNB); 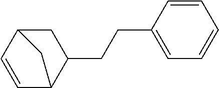 [SMILES: C1=CC2CC1CC2CCc1ccccc1]
5-phenethylbicyclo[2.2.1]hept-2-ene (PENB); 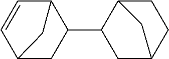 [SMILES: C1=CC2CC1CC2C1CC2CCC1C2]
2,2′-bi(bicyclo[2.2.1]heptan-5-ene) (NBANB); 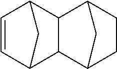 [SMILES: C1=CC2CC1C1C3CCC(C3)C21]
1,2,3,4,4a,5,8,8a-octahydro-1,4:5,8-dimethanonaphthalene (TD); and 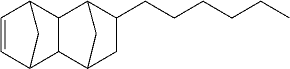 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD); 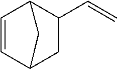
5-vinylbicyclo[2.2.1]hept-2-ene (VNB); 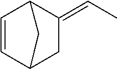
5-ethylidenebicyclo[2.2.1]hept-2-ene (ENB); 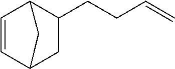
5-(but-3-en-1-yl)bicyclo[2.2.1]hept-2-ene (ButenylNB); 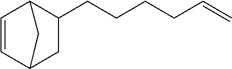
5-(hex-5-en-1-yl)bicyclo[2.2.1]hept-2-ene (HexenylNB); 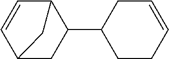 [SMILES: C1=CCC(C2CC3C=CC2C3)CC1]
5-(cyclohex-3-en-1-yl)bicyclo[2.2.1]hept-2-ene (CyHexeneNB); 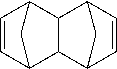 [SMILES: C1=CC2CC1C1C3C=CC(C3)C21] 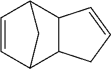
3a,4,7,7a-tetrahydro-1H-4,7-methanoindene (DCPD); and 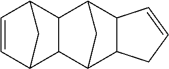 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3);
and 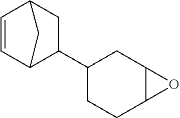 [SMILES: C1=CC2CC1CC2C1CCC2OC2C1]
3-(bicyclo[2.2.1]hept-5-en-2-yl)-7-oxabicyclo[4.1.0]heptane (CHEpNB).

7. The composition according to claim 5, wherein the first repeat unit of the polymer is derived from the monomer of formula (I) selected from the group consisting of: 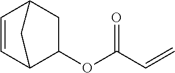
bicyclo[2.2.1]hept-5-en-2-yl acrylate (NB-acrylate); 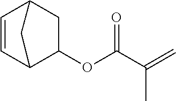
bicyclo[2.2.1]hept-5-en-2-yl methacrylate (NB-methacrylate); 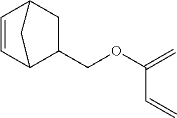
bicyclo[2.2.1]hept-5-en-2-ylmethyl acrylate (NBCH2-acrylate); and 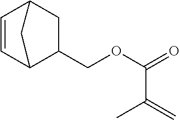
bicyclo[2.2.1]hept-5-en-2-ylmethyl methacrylate (NBCH2-methacrylate).

8. The composition according to claim 5, wherein the compound of formula (III) is selected from the group consisting of: 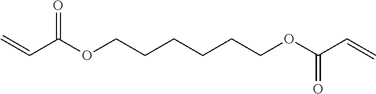 [SMILES: C=CC(=O)OCCCCCCOC(=O)C=C]
hexane-1,6-diyl diacrylate (Hex-diacrylate); 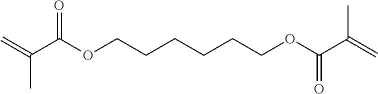 [SMILES: C=C(C)C(=O)OCCCCCCOC(=O)C(=C)C]
hexane-1,6-diyl bis(2-methylacrylate) (Hex-dimethacrylate); 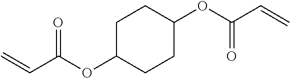 [SMILES: C=CC(=O)OC1CCC(OC(=O)C=C)CC1]
cyclohexane-1,4-diyl diacrylate (1,4-CyHex-diacrylate); 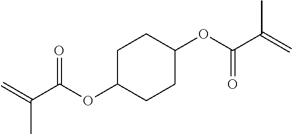 [SMILES: C=C(C)C(=O)OC1CCC(OC(=O)C(=C)C)CC1]
cyclohexane-1,4-diyl bis(2-methylacrylate) (1,4-CyHex-dimethacrylate); 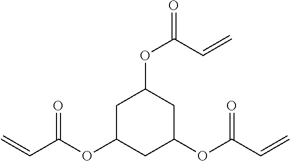 [SMILES: C=CC(=O)OC1CC(OC(=O)C=C)CC(OC(=O)C=C)C1]
cyclohexane-1,3,5-triyl triacrylate (1,3,6-CyHex-triacrylate); 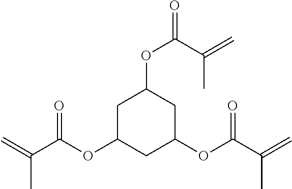 [SMILES: C=C(C)C(=O)OC1CC(OC(=O)C(=C)C)CC(OC(=O)C(=C)C)C1] 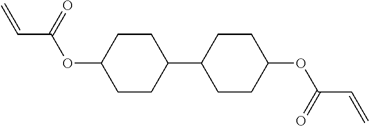 [SMILES: C=CC(=O)OC1CCC(C2CCC(OC(=O)C=C)CC2)CC1]
[1,1′-bi(cyclohexane)]-4,4′-diyl diacrylate (di-CyHex-diacrylate); 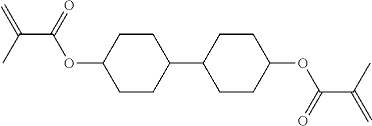 [SMILES: C=C(C)C(=O)OC1CCC(C2CCC(OC(=O)C(=C)C)CC2)CC1]
[1,1′-bi(cyclohexane)]-4,4′-diyl bis(2-methylacrylate) (di-CyHex-dimethacrylate); 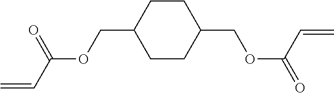 [SMILES: C=CC(=O)OCC1CCC(COC(=O)C=C)CC1]
cyclohexane-1,4-diylbis(methylene) diacrylate (1,4-CyHex(CH₂acrylate)₂); 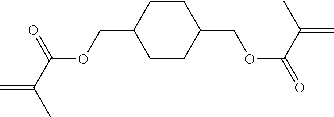 [SMILES: C=C(C)C(=O)OCC1CCC(COC(=O)C(=C)C)CC1]
cyclohexane-1,4-diylbis(methylene) bis(2-methylacrylate) (1,4-CyHex(CH₂methacrylate)₂); 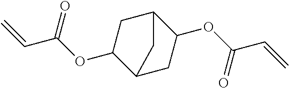 [SMILES: C=CC(=O)OC1CC2CC1CC2OC(=O)C=C]
bicyclo[2.2.1]heptane-2,5-diyl diacrylate (NB-diacrylate); 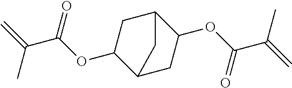 [SMILES: C=C(C)C(=O)OC1CC2CC1CC2OC(=O)C(=C)C]
bicyclo[2.2.1]heptane-2,5-diyl bis(2-methylacrylate) (NB-dimethacrylate); 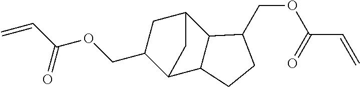 [SMILES: C=CC(=O)OCC1CC2CC1C1CCC(COC(=O)C=C)C21]
(octahydro-1H-4,7-methanoindene-1,5-diyl)bis(methylene) diacrylate (NB—CP(CH₂-acrylate)₂) 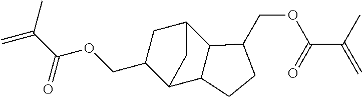 [SMILES: C=C(C)C(=O)OCC1CC2CC1C1CCC(COC(=O)C(=C)C)C21]
(octahydro-1H-4,7-methanoindene-1,5-diyl)bis(methylene) bis(2-methylacrylate) (NB—CP(CH₂-methacrylate)₂); 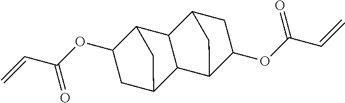 [SMILES: C=CC(=O)OC1CC2CC1C1C3CC(OC(=O)C=C)C(C3)C21]
decahydro-1,4:5,8-dimethanonaphthalene-2,6-diyl diacrylate (TD-diacrylate); 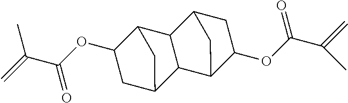 [SMILES: C=C(C)C(=O)OC1CC2CC1C1C3CC(OC(=O)C(=C)C)C(C3)C21]
decahydro-1,4:5,8-dimethanonaphthalene-2,6-diyl bis(2-methylacrylate) (TD-dimethacrylate); and 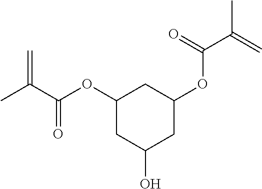 [SMILES: C=C(C)C(=O)OC1CC(O)CC(OC(=O)C(=C)C)C1]
5-hydroxycyclohexane-1,3-diyl bis(2-methylacrylate) (CyHex(OH)dimethacrylate).

9. The composition according to claim 5, wherein the compound of formula (IV) is selected from the group consisting of: 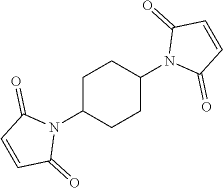 [SMILES: O=C1C=CC(=O)N1C1CCC(N2C(=O)C=CC2=O)CC1]
1,1′-(cyclohexane-1,4-diyl)bis(1H-pyrrole-2,5-dione) (1,4-CyHex(MI)₂); 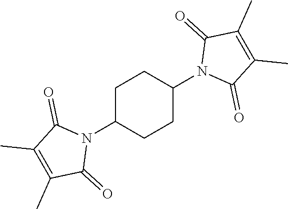
1,1′-(cyclohexane-1,4-diyl)bis(3,4-dimethyl-1H-pyrrole-2,5-dione) (CyHex(DMMI)₂); 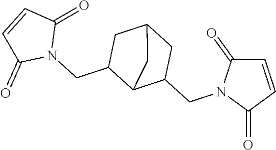 [SMILES: O=C1C=CC(=O)N1CC1CC2CC(CN3C(=O)C=CC3=O)C1C2]
1,1′-(bicyclo[2.2.1]heptane-2,6-diylbis(methylene))bis(1H-pyrrole-2,5-dione) (2,6-NB(CH₂-MI)₂); 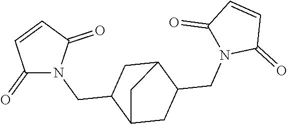 [SMILES: O=C1C=CC(=O)N1CC1CC2CC1CC2CN1C(=O)C=CC1=O]
1,1′-(bicyclo[2.2.1]heptane-2,5-diylbis(methylene))bis(1H-pyrrole-2,5-dione) (2,5-NB(CH₂-MI)₂); 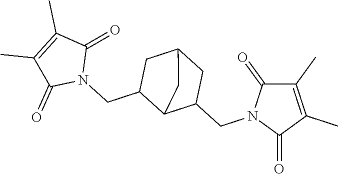
1,1′-(bicyclo[2.2.1]heptane-2,6-diylbis(methylene))bis(3,4-dimethyl-1H-pyrrole-2,5-dione) (2,6-NB(CH₂-DMMI)₂); and 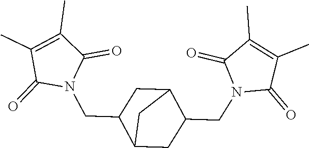
1,1′-(bicyclo[2.2.1]heptane-2,5-diylbis(methylene))bis(3,4-dimethyl-1H-pyrrole-2,5-dione) (2,5-NB(CH₂-DMMI)₂).

10. The composition according to claim 5, wherein the tackifier is selected from the group consisting of: 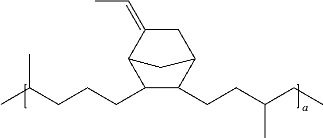
ethylene-propylene-ethylidenenorbornene terpolymer, where a is at least 100; 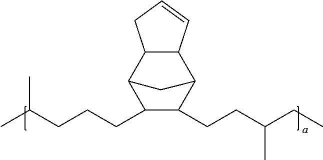
ethylene-propylene-dicyclopentadiene terpolymer, where a is at least 100; 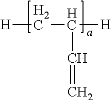
1,2-butadiene rubber, where a is at least 100; 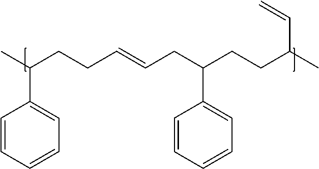
styrene/butadiene rubbers 1; 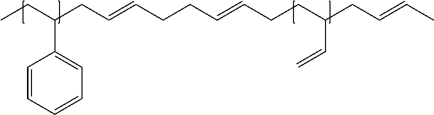
styrene/butadiene rubbers 2; 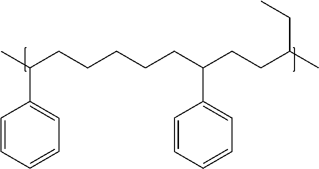
hydrogenated styrene/butadiene rubbers 1; and 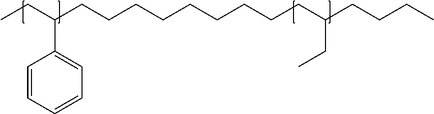
hydrogenated styrene/butadiene rubbers 2.

11. The composition according to claim 5, wherein the free radical generator is selected from the group consisting of: 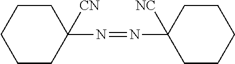 [SMILES: N#CC1(N=NC2(C#N)CCCCC2)CCCCC1]
1,1′-(diazene-1,2-diyl)bis(cyclohexane-1-carbonitrile); 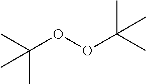
di-tert-butyl peroxide; 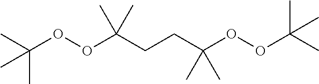 [SMILES: CC(C)(C)OOC(C)(C)CCC(C)(C)OOC(C)(C)C]
2,5-bis(tert-butylperoxy)-2,5-dimethylhexane; 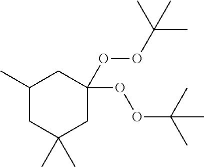 [SMILES: CC1CC(C)(C)CC(OOC(C)(C)C)(OOC(C)(C)C)C1]
1,1-bis(tert-butylperoxy)-3,3,5-trimethylcyclohexane; 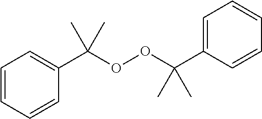 [SMILES: CC(C)(OOC(C)(C)c1ccccc1)c1ccccc1]
dicumyl peroxide (DCP); 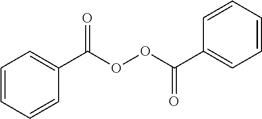 [SMILES: O=C(OOC(=O)c1ccccc1)c1ccccc1]
benzoyl peroxide; 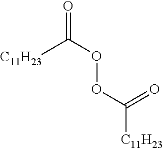
dodecanoic peroxyanhydride 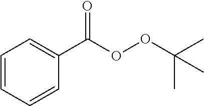
tert-butyl benzoperoxoate; and 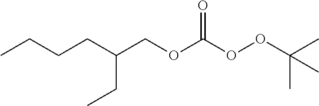 [SMILES: CCCCC(CC)COC(=O)OOC(C)(C)C]
tert-butyl (2-ethylhexyl) carbonoperoxoate.

12. The composition according to claim 5, which is selected from the group consisting of:
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate);
and dicumyl peroxide (DCP);
a solution containing a mixture of a tetrapolymer of norbornene (NB), 5-hexylbicyclo[2.2.1]hept-2-ene (HexNB), 5-cyclohexylbicyclo[2.2.1]hept-2-ene (CyHexaneNB) and bicyclo[2.2.1]hept-5-en-2-yl methacrylate (NB-methacrylate); 1,2-butadiene rubber, ethylene-propylene-ethylidenenorbornene terpolymer, 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,2-butadiene rubber, ethylene-propylene-ethylidenenorbornene terpolymer, 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); cyclohexane-1,4-diyl bis(2-methylacrylate) (1,4-CyHex-dimethacrylate), 1,2-butadiene rubber, ethylene-propylene-ethylidenenorbornene terpolymer, 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,3,5-CyHex(trimethacrylate), 1,2-butadiene rubber, ethylene-propylene-ethylidenenorbornene terpolymer, 1,3,5-triallyl-1,3,5-triazinane-2,4,6-trione (TAIC) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,1′-(bicyclo[2.2.1]heptane-2,5-diylbis(methylene))bis(3,4-dimethyl-1H-pyrrole-2,5-dione) (2,5-NB(CH₂-DMMI)₂) and dicumyl peroxide (DCP);
a solution containing a mixture of a tetrapolymer of norbornene (NB), 5-hexylbicyclo[2.2.1]hept-2-ene (HexNB), 5-(cyclohex-3-en-1-yl)bicyclo[2.2.1]hept-2-ene (CyHexeneNB) and bicyclo[2.2.1]hept-5-en-2-yl methacrylate (NB-methacrylate); 1,1′-(bicyclo[2.2.1]heptane-2,5-diylbis(methylene))bis(3,4-dimethyl-1H-pyrrole-2,5-dione) (2,5-NB(CH₂-DMMI)₂), ethylene-propylene-ethylidenenorbornene terpolymer and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber and dicumyl peroxide (DCP);
a solution containing a mixture of a terpolymer of norbornene (NB), 5-hexylbicyclo[2.2.1]hept-2-ene (HexNB) and 5-(but-3-en-1-yl)bicyclo[2.2.1]hept-2-ene (ButenylNB); cyclohexane-1,4-diyl bis(2-methylacrylate) (1,4-CyHex-dimethacrylate), 1,2-butadiene rubber and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber, ethylene-propylene-ethylidenenorbornene terpolymer, (NB-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); cyclohexane-1,4-diyl bis(2-methylacrylate) (1,4-CyHex-dimethacrylate), 1,2-butadiene rubber, ethylene-propylene-ethylidenenorbornene terpolymer, (di-CyHex-dimethacrylate) and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,4-CyHex(MI)₂ and dicumyl peroxide (DCP);
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,1′-(bicyclo[2.2.1]heptane-2,5-diylbis(methylene))bis(3,4-dimethyl-1H-pyrrole-2,5-dione) (2,5-NB(CH₂-DMMI)₂) and dicumyl peroxide (DCP); and
a solution containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyHexeneNB); 1,1′-(bicyclo[2.2.1]heptane-2,5-diylbis(methylene))bis(3,4-dimethyl-1H-pyrrole-2,5-dione) (2,5-NB(CH₂-DMMI)₂), ethylene-propylene-ethylidenenorbornene terpolymer and dicumyl peroxide (DCP).

13. A film formed from the composition according to claim 5.

14. A film forming composition comprising:
a) one or more olefinic monomers of formula (I): 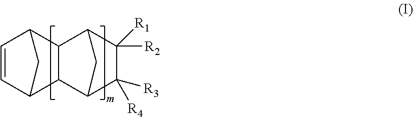
wherein:
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl, (C₆-C₁₂)aryl(C₁-C₆)alkyl, methylidene, ethylidene, vinyl, linear or branched (C₃-C₁₆)alkenyl, (C₃-C₁₀)cycloalkenyl, (C₆-C₁₂)bicycloalkenyl, (C₆-C₁₂)aryl(C₂-C₁₆)alkenyl, epoxy(C₁-C₆)alkyl and epoxy(C₃-C₈)cycloalkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) optionally a monomer of formula (II): 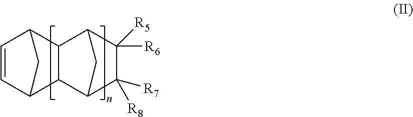
wherein:
n is an integer 0, 1 or 2;
at least one of R₅, R₆, R₇ and R₈ is selected from the group consisting of acrylate, methacrylate, (C₁-C₆)alkylacrylate and (C₁-C₆)alkylmethacrylate, and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
c) an organopalladium compound selected from the group consisting of:
palladium (II) bis(triphenylphosphine) dichloride;
palladium (II) bis(triphenylphosphine) dibromide;
palladium (II) bis(triphenylphosphine) diacetate;
palladium (II) bis(triphenylphosphine) bis(trifluoroacetate);
palladium (II) bis(tricyclohexylphosphine) dichloride;
palladium (II) bis(tricyclohexylphosphine) dibromide;
palladium (II) bis(tricyclohexylphosphine) diacetate (Pd785);
palladium (II) bis(tricyclohexylphosphine) bis(trifluoroacetate);
palladium (II) bis(tri-p-tolylphosphine) dichloride;
palladium (II) bis(tri-p-tolylphosphine) dibromide;
palladium (II) bis(tri-p-tolylphosphine) diacetate;
palladium (II) bis(tri-p-tolylphosphine) bis(trifluoroacetate);
palladium (II) ethyl hexanoate;
dichloro bis(acetonato)palladium (II);
dichloro bis(benzonitrile)palladium (II);
platinum (II) chloride;
platinum (II) bromide; and
platinum bis(triphenylphosphine)dichloride; and
d) an activator selected from the group consisting of:
lithium tetrafluoroborate;
lithium triflate;
lithium tetrakis(pentafluorophenyl)borate;
lithium tetrakis(pentafluorophenyl)borate etherate (LiFABA);
lithium tetrakis(pentafluorophenyl)borate isopropanolate;
lithium tetraphenylborate;
lithium tetrakis(3,5-bis(trifluoromethyl)phenyl)borate;
lithium tetrakis(2-fluorophenyl)borate;
lithium tetrakis(3-fluorophenyl)borate;
lithium tetrakis(4-fluorophenyl)borate;
lithium tetrakis(3,5-difluorophenyl)borate;
lithium hexafluorophosphate;
lithium hexaphenylphosphate;
lithium hexakis(pentafluorophenyl)phosphate;
lithium hexafluoroarsenate;
lithium hexaphenylarsenate;
lithium hexakis(pentafluorophenyl)arsenate;
lithium hexakis(3,5-bis(trifluoromethyl)phenyl)arsenate;
lithium hexafluoroantimonate;
lithium hexaphenylantimonate;
lithium hexakis(pentafluorophenyl)antimonate;
lithium hexakis(3,5-bis(trifluoromethyl)phenyl)antimonate;
lithium tetrakis(pentafluorophenyl)aluminate;
lithium tris(nonafluorobiphenyl)fluoroaluminate;
lithium (octyloxy)tris(pentafluorophenyl)aluminate;
lithium tetrakis(3,5-bis(trifluoromethyl)phenyl)aluminate;
lithium methyltris(pentafluorophenyl)aluminate;
dimethylanilinium tetrakis(pentafluorophenyl)borate (DANFABA);
e) a crosslinking agent selected from the group consisting of: 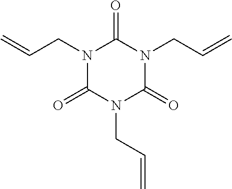 [SMILES: C=CCn1c(=O)n(CC=C)c(=O)n(CC=C)c1=O]
1,3,5-triallyl-1,3,5-triazinane-2,4,6-trione (TAIC); 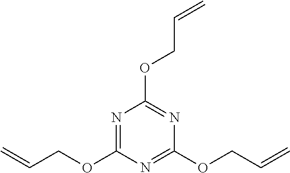 [SMILES: C=CCOc1nc(OCC=C)nc(OCC=C)n1]
2,4,6-tris(allyloxy)-1,3,5-triazine (TAC);
a compound of formula (III):
X-(A)ₚ (III)
wherein,
p is an integer from 2 to 6;
A is acrylate or methacylate;
X is selected from the group consisting of substituted or unsubstituted (C₁-C₁₆)alkyl,
(C₃-C₁₆)cycloalkyl, (C₃-C₁₆)cycloalkyl(C₁-C₆)alkyl, (C₆-C₁₆)bicycloalkyl,
(C₆-C₁₆)bicycloalkyl(C₁-C₆)alkyl, (C₅-C₁₆)tricycloalkyl,
(C₈-C₁₆)tricycloalkyl(C₁-C₆)alkyl, (C₈-C₁₆)tricycloalkyl and
(C₈-C₁₆)tricycloalkyl(C₁-C₆)alkyl; and
a compound of formula (IV):
Y—(B)_{q} (IV)
wherein,
q is an integer from 2 to 6;
B is a radical of formula (V): 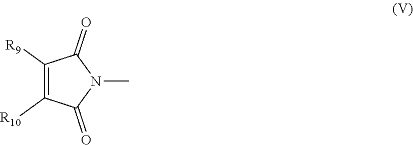
wherein R₉ and R₁₀ are the same or different and each independently selected from the group consisting of hydrogen, methyl, ethyl and linear or branched (C₃-C₆)alkyl;
Y is selected from the group consisting of substituted or unsubstituted
(C₃-C₁₆)cycloalkyl, (C₃-C₁₆)cycloalkyl(C₁-C₆)alkyl, (C₆-C₁₆)bicycloalkyl,
(C₆-C₁₆)bicycloalkyl(C₁-C₆)alkyl, (C₈-C₁₆)tricycloalkyl and
(C₈-C₁₆)tricycloalkyl(C₁-C₆)alkyl; and
a mixture in any combination thereof; and
f) one or more additives selected from the group consisting of a tackifier and a free radical initiator;
with the proviso that when a monomer of formula (II) is absent then the composition contains at least one compound of formula (III) or one compound of formula (IV); and
wherein the film formed from the composition has a dielectric constant (Dk) less than 2.4 at a frequency of 10 GHz, a glass transition temperature greater than 200° C. and a coefficient of thermal expansion (CTE) less than 180 ppm/K.

15. The composition according to claim 14, wherein the monomer of formula (I) is selected from the group consisting of: 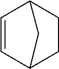
bicyclo[2.2.1]hept-2-ene (norbornene or NB); 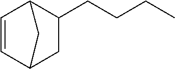
5-butylbicyclo[2.2.1]hept-2-ene (BuNB); 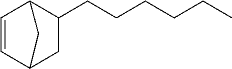
5-hexylbicyclo[2.2.1]hept-2-ene (HexNB); 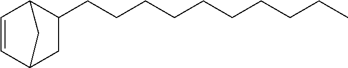 [SMILES: CCCCCCCCCCC1CC2C=CC1C2]
5-decylbicyclo[2.2.1]hept-2-ene (DecNB); 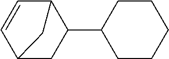 [SMILES: C1=CC2CC1CC2C1CCCCC1]
5-cyclohexylbicyclo[2.2.1]hept-2-ene (CyHexaneNB); 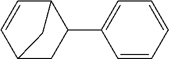 [SMILES: C1=CC2CC1CC2c1ccccc1]
5-phenylbicyclo[2.2.1]hept-2-ene (PhNB); 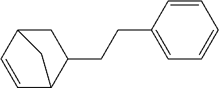 [SMILES: C1=CC2CC1CC2CCc1ccccc1]
5-phenethylbicyclo[2.2.1]hept-2-ene (PENB); 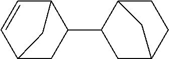 [SMILES: C1=CC2CC1CC2C1CC2CCC1C2]
2,2′-bi(bicyclo[2.2.1]heptan-5-ene) (NBANB); 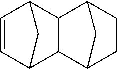 [SMILES: C1=CC2CC1C1C3CCC(C3)C21]
1,2,3,4,4a,5,8,8a-octahydro-1,4:5,8-dimethanonaphthalene (TD); 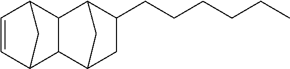 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD); 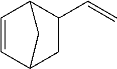
5-vinylbicyclo[2.2.1]hept-2-ene (VNB); 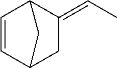
5-ethylidenebicyclo[2.2.1]hept-2-ene (ENB); 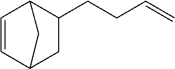
5-(but-3-en-1-yl)bicyclo[2.2.1]hept-2-ene (ButenylNB); 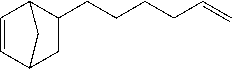
5-(hex-5-en-1-yl)bicyclo[2.2.1]hept-2-ene (HexenylNB); 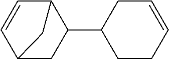 [SMILES: C1=CCC(C2CC3C=CC2C3)CC1]
5-(cyclohex-3-en-1-yl)bicyclo[2.2.1]hept-2-ene (CyHexeneNB); 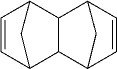 [SMILES: C1=CC2CC1C1C3C=CC(C3)C21] 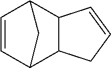
3a,4,7,7a-tetrahydro-1H-4,7-methanoindene (DCPD); and 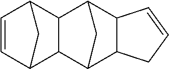 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3);
and 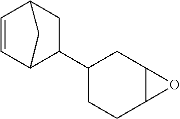 [SMILES: C1=CC2CC1CC2C1CCC2OC2C1]
3-(bicyclo[2.2.1]hept-5-en-2-yl)-7-oxabicyclo[4.1.0]heptane (CHEpNB).

16. The composition according to claim 14, wherein the monomer of formula (II) is selected from the group consisting of: 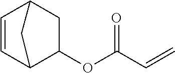
bicyclo[2.2.1]hept-5-en-2-yl acrylate (NB-acrylate); 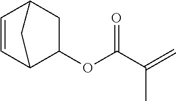
bicyclo[2.2.1]hept-5-en-2-yl methacrylate (NB-methacrylate); 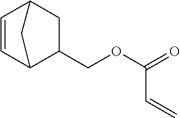
bicyclo[2.2.1]hept-5-en-2-ylmethyl acrylate (NBCH2-acrylate); and 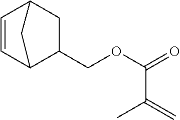
bicyclo[2.2.1]hept-5-en-2-ylmethyl methacrylate (NBCH2-methacrylate).

17. The composition according to claim 14, wherein the compound of formula (III) is selected from the group consisting of: 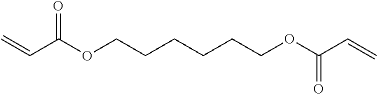 [SMILES: C=CC(=O)OCCCCCCOC(=O)C=C]
hexane-1,6-diyl diacrylate (Hex-diacrylate); 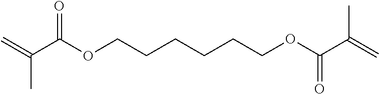 [SMILES: C=C(C)C(=O)OCCCCCCOC(=O)C(=C)C]
hexane-1,6-diyl bis(2-methylacrylate) (Hex-dimethacrylate); 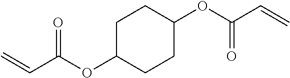 [SMILES: C=CC(=O)OC1CCC(OC(=O)C=C)CC1]
cyclohexane-1,4-diyl diacrylate (1,4-CyHex-diacrylate); 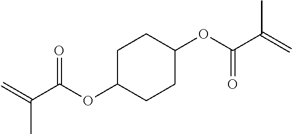 [SMILES: C=C(C)C(=O)OC1CCC(OC(=O)C(=C)C)CC1]
cyclohexane-1,4-diyl bis(2-methylacrylate) (1,4-CyHex-dimethacrylate); 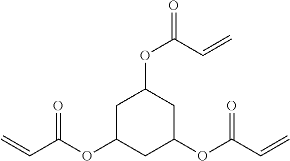 [SMILES: C=CC(=O)OC1CC(OC(=O)C=C)CC(OC(=O)C=C)C1]
cyclohexane-1,3,5-triyl triacrylate (1,3,6-CyHex-triacrylate); 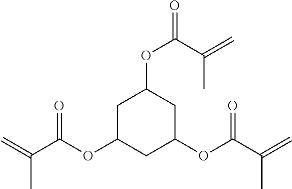 [SMILES: C=C(C)C(=O)OC1CC(OC(=O)C(=C)C)CC(OC(=O)C(=C)C)C1]
cyclohexane-1,3,5-triyl tris(2-methylacrylate) (1,3,5-CyHex-trimethacrylate); 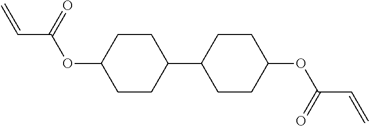 [SMILES: C=CC(=O)OC1CCC(C2CCC(OC(=O)C=C)CC2)CC1]
[1,1′-bi(cyclohexane)]-4,4′-diyl diacrylate (di-CyHex-diacrylate); 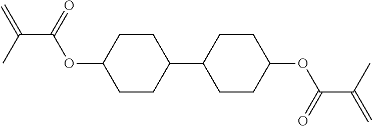 [SMILES: C=C(C)C(=O)OC1CCC(C2CCC(OC(=O)C(=C)C)CC2)CC1]
[1,1′-bi(cyclohexane)]-4,4′-diyl bis(2-methylacrylate) (di-CyHex-dimethacrylate); 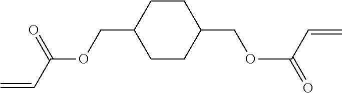
cyclohexane-1,4-diylbis(methylene) diacrylate (1,4-CyHex(CH₂acrylate)₂); 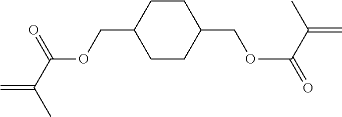
cyclohexane-1,4-diylbis(methylene) bis(2-methylacrylate) (1,4-CyHex(CH₂methacrylate)₂); 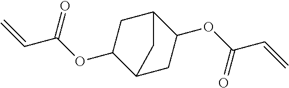 [SMILES: C=CC(=O)OC1CC2CC1CC2OC(=O)C=C]
bicyclo[2.2.1]heptane-2,5-diyl diacrylate (NB-diacrylate); 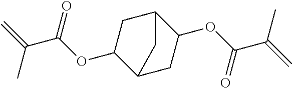 [SMILES: C=C(C)C(=O)OC1CC2CC1CC2OC(=O)C(=C)C]
bicyclo[2.2.1]heptane-2,5-diyl bis(2-methylacrylate) (NB-dimethacrylate); 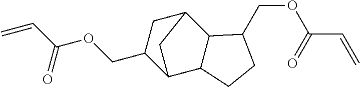 [SMILES: C=CC(=O)OCC1CC2CC1C1CCC(COC(=O)C=C)C21]
(octahydro-1H-4,7-methanoindene-1,5-diyl)bis(methylene) diacrylate (NB—CP(CH₂-acrylate)₂); 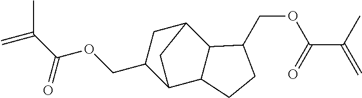 [SMILES: C=C(C)C(=O)OCC1CC2CC1C1CCC(COC(=O)C(=C)C)C21]
(octahydro-1H-4,7-methanoindene-1,5-diyl)bis(methylene) bis(2-methylacrylate) (NB—CP(CH₂-methacrylate)₂); 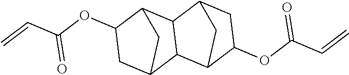 [SMILES: C=CC(=O)OC1CC2CC1C1C3CC(OC(=O)C=C)C(C3)C21]
decahydro-1,4:5,8-dimethanonaphthalene-2,6-diyl diacrylate (TD-diacrylate); 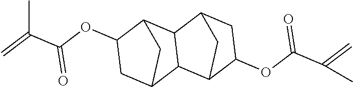 [SMILES: C=C(C)C(=O)OC1CC2CC1C1C3CC(OC(=O)C(=C)C)C(C3)C21]
decahydro-1,4:5,8-dimethanonaphthalene-2,6-diyl bis(2-methylacrylate) (TD-dimethacrylate); and 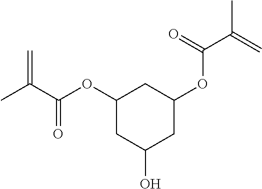 [SMILES: C=C(C)C(=O)OC1CC(O)CC(OC(=O)C(=C)C)C1]
5-hydroxycyclohexane-1,3-diyl bis(2-methylacrylate) (CyHex(OH)dimethacrylate).

18. The composition according to claim 14, wherein the compound of formula (IV) is selected from the group consisting of: 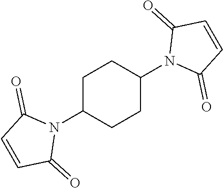 [SMILES: O=C1C=CC(=O)N1C1CCC(N2C(=O)C=CC2=O)CC1]
1,1′-(cyclohexane-1,4-diyl)bis(1H-pyrrole-2,5-dione) (1,4-CyHex(MI)₂); 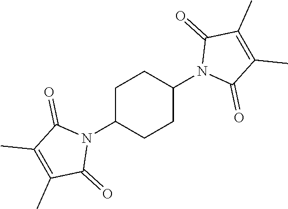
1,1′-(cyclohexane-1,4-diyl)bis(3,4-dimethyl-1H-pyrrole-2,5-dione) (CyHex(DMMI)₂); 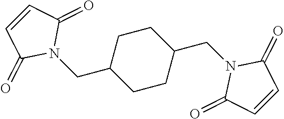 [SMILES: O=C1C=CC(=O)N1CC1CCC(CN2C(=O)C=CC2=O)CC1]
1,1′-(cyclohexane-1,4-diylbis(methylene))bis(1H-pyrrole-2,5-dione) (1,4-CyHexCH₂-MI₂); 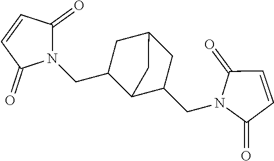 [SMILES: O=C1C=CC(=O)N1CC1CC2CC(CN3C(=O)C=CC3=O)C1C2]
1,1′-(bicyclo[2.2.1]heptane-2,6-diylbis(methylene))bis(1H-pyrrole-2,5-dione) (2,6-NB(CH₂-MI)₂); 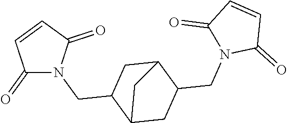 [SMILES: O=C1C=CC(=O)N1CC1CC2CC1CC2CN1C(=O)C=CC1=O]
1,1′-(bicyclo[2.2.1]heptane-2,5-diylbis(methylene))bis(1H-pyrrole-2,5-dione) (2,5-NB(CH₂-MI)₂); 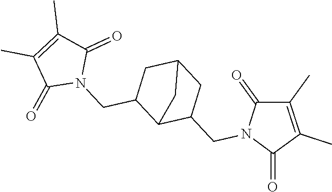
1,1′-(bicyclo[2.2.1]heptane-2,6-diylbis(methylene))bis(3,4-dimethyl-1H-pyrrole-2,5-dione) (2,6-NB(CH₂-DMMI)₂); and 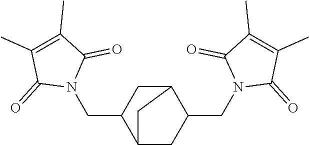
1,1′-(bicyclo[2.2.1]heptane-2,5-diylbis(methylene))bis(3,4-dimethyl-1H-pyrrole-2,5-dione) (2,5-NB(CH₂-DMMI)₂).

19. The composition according to claim 14, wherein the tackifier is selected from the group consisting of: 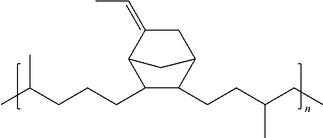
ethylene-propylene-ethylidenenorbornene terpolymer, where n is at least 100; 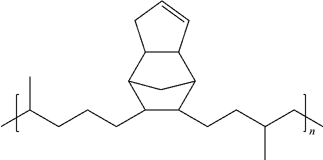
ethylene-propylene-dicyclopentadiene terpolymer, where n is at least 100; 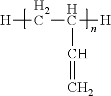
1,2-butadiene rubber, where n is at least 100; 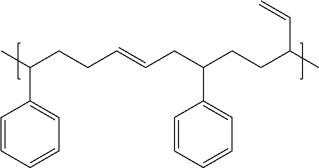
styrene/butadiene rubbers 1; 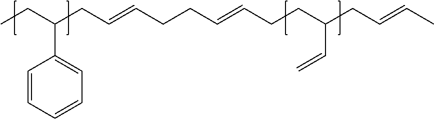
styrene/butadiene rubbers 2; 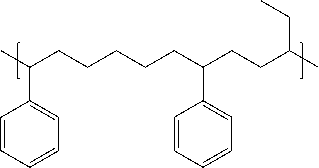
hydrogenated styrene/butadiene rubbers 1; and 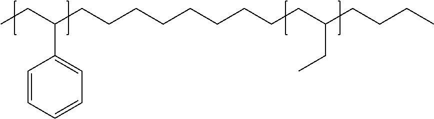
hydrogenated styrene/butadiene rubbers 2; and
the free radical generator is selected from the group consisting of: 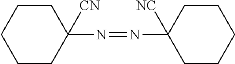 [SMILES: N#CC1(N=NC2(C#N)CCCCC2)CCCCC1]
1,1′-(diazene-1,2-diyl)bis(cyclohexane-1-carbonitrile); 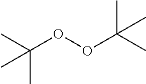
di-tert-butyl peroxide; 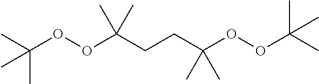 [SMILES: CC(C)(C)OOC(C)(C)CCC(C)(C)OOC(C)(C)C]
2,5-bis(tert-butylperoxy)-2,5-dimethylhexane; 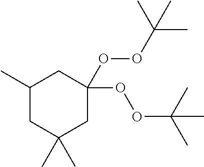 [SMILES: CC1CC(C)(C)CC(OOC(C)(C)C)(OOC(C)(C)C)C1]
1,1-bis(tert-butylperoxy)-3,3,5-trimethylcyclohexane; 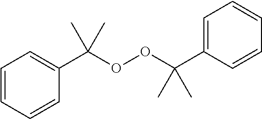 [SMILES: CC(C)(OOC(C)(C)c1ccccc1)c1ccccc1]
dicumyl peroxide (DCP); 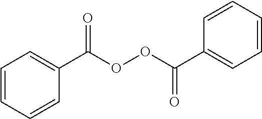 [SMILES: O=C(OOC(=O)c1ccccc1)c1ccccc1]
benzoyl peroxide; 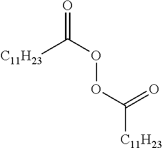
dodecanoic peroxyanhydride; 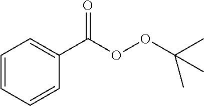
tert-butyl benzoperoxoate; and 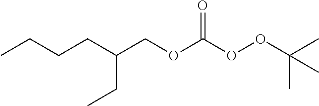 [SMILES: CCCCC(CC)COC(=O)OOC(C)(C)C]
tert-butyl (2-ethylhexyl) carbonoperoxoate.

20. The composition according to claim 5, which is selected from the group consisting of:
a mixture of 5-hexylbicyclo[2.2.1]hept-2-ene (HexNB), bicyclo[2.2.1]hept-5-en-2-yl methacrylate (NB-methacrylate), 3,5-bis(1,1-dimethylethyl)-4-hydroxy-octadecyl ester benzenepropanoic acid, tris(2,4-ditert-butylphenyl)phosphite, palladium (II) bis(tricyclohexylphosphine) diacetate (Pd785), dimethylanilinium tetrakis(pentafluorophenyl)borate (DANFABA);
a mixture of 5-hexylbicyclo[2.2.1]hept-2-ene (HexNB), bicyclo[2.2.1]hept-5-en-2-yl methacrylate (NB-methacrylate), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-(but-3-en-1-yl)bicyclo[2.2.1]hept-2-ene (ButenylNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-(cyclohex-3-en-1-yl)bicyclo[2.2.1]hept-2-ene (CyHexeneNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), bicyclo[2.2.1]hept-5-en-2-yl methacrylate (NB-methacrylate), 5-cyclohexylbicyclo[2.2.1]hept-2-ene (CyHexaneNB), palladium (II) bis(tricyclohexylphosphine) diacetate (Pd785), dimethylanilinium tetrakis(pentafluorophenyl)borate (DANFABA) and dicumyl peroxide (DCP);
a mixture of 5-hexylbicyclo[2.2.1]hept-2-ene (HexNB), 5-(cyclohex-3-en-1-yl)bicyclo[2.2.1]hept-2-ene (CyHexeneNB), (octahydro-1H-4,7-methanoindene-1,5-diyl)bis(methylene) bis(2-methylacrylate) (NB—CP(CH₂-methacrylate)₂), palladium (II) bis(tricyclohexylphosphine) diacetate (Pd785), dimethylanilinium tetrakis(pentafluorophenyl)borate (DANFABA) and dicumyl peroxide (DCP); and
a mixture of 5-hexylbicyclo[2.2.1]hept-2-ene (HexNB), 5-(cyclohex-3-en-1-yl)bicyclo[2.2.1]hept-2-ene (CyHexeneNB), palladium (II) bis(tricyclohexylphosphine) diacetate (Pd785), dimethylanilinium tetrakis(pentafluorophenyl)borate (DANFABA), cyclohexane-1,4-diyl bis(2-methylacrylate) (1,4-CyHex-dimethacrylate), di-tert-butyl peroxide (DTBP) or di-cumyl peroxide (DCP).
